(19) United States
(12) Patent Application Publication
(10) Pub. No.: US 2020/0076784 A1
(43) Pub. Date: Mar. 5, 2020

(54) In-Line Resolution of an Entity's Identity

(71) Applicant: Forcepoint, LLC, Austin, TX (US)

(72) Inventors: William Renner, Baltimore, MD (US); Phillip Bracikowski, Indianapolis, IN (US); Russell Snyder, Baltimore, MD (US); Christopher Poirel, Baltimore, MD (US)

(21) Appl. No.: 16/360,264

(22) Filed: Mar. 21, 2019

Related U.S. Application Data
(63) Continuation of application No. 16/121,138, filed on Sep. 4, 2018.

(51) Int. Cl. H04L 29/06

(52) U.S. Cl. CPC H04L 63/08; H04L 63/083; H04L 63/0861

(57) ABSTRACT

A system, method, and computer-readable medium for resolving an identity of an entity, comprising: parsing entity identifier information, the parsing generating entity identifier elements from the entity identifier information; classifying an entity identifier element type; normalizing an entity identifier element to provide a normalized entity identifier element; and, associating the normalized entity identifier element with an entity to resolve the identity of the entity.

### BACKGROUND OF THE INVENTION

### Field of the Invention

The present invention relates in general to the field of computers and similar technologies, and in particular to software utilized in this field. Still more particularly, it relates to a method, system and computer-usable medium for in-line resolution of an entity's identity.

### Description of the Related Art

Users interact with physical, system, data, and services resources of all kinds, as well as each other, on a daily basis. Each of these interactions, whether accidental or intended, poses some degree of security risk. However, not all behavior poses the same risk. Furthermore, determining the extent of risk corresponding to individual events can be difficult. In particular, ensuring that an entity is who they claim to be can be challenging.

As an example, a first user may attempt to pose as a second user to gain access to certain confidential information. In this example, the first user may be prevented from accessing the confidential information if it can be determined that they are illegitimately posing as the second user. More particularly, access to the confidential information may be prevented if the identity of the first user is resolved prior to the confidential information actually being accessed. Likewise, the first user's access to the confidential information may be prevented if their identity cannot be resolved to the identity of the second user.

### SUMMARY OF THE INVENTION

A system, method, and computer-readable medium for in-line resolution of an entity's identity.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented;

FIG. 2 is a simplified block diagram of an edge device;

FIG. 3 is a simplified block diagram of an endpoint agent;

FIG. 4 is a simplified block diagram of a security analytics system;

FIG. 5 is a simplified block diagram of the operation of a security analytics system;

FIG. 6 is a generalized process flow diagram of the performance of event preprocessing operations;

FIG. 7 is a simplified block diagram of an in-line entity resolution system;

FIGS. 8a and 8b are a simplified block diagram of the operation of a security analytics system;

FIG. 9 is a simplified block diagram of a security analytics system implemented to provide in-line resolution of an entity's identity;

FIG. 10 is a simplified block diagram of the performance of entity identifier classification operations;

FIG. 11 is a simplified block diagram of the performance of entity identifier normalization operations;

FIG. 12 is a generalized flowchart of the performance of entity identifier element type classification and normalization operations;

FIGS. 13a and 13b are a generalized flowchart of the performance of operations for in-line resolution of an entity's identity.

### DETAILED DESCRIPTION

A method, system and computer-usable medium for in-line resolution of an entity's identity. Certain embodiments of the invention reflect an appreciation that the occurrence of an event may be associated with anomalous, abnormal, unexpected or malicious user behavior enacted by an entity, as described in greater detail herein. Likewise, certain embodiments of the invention reflect an appreciation that such user behavior may be associated with one or more processes, each of which may include a series of process steps. Certain embodiments of the invention likewise reflect an appreciation that being able to resolve the identity of an entity prior to the next step of such a process being performed may assist in mitigating risk corresponding to certain user behavior associated with a particular event. Furthermore, certain embodiments of the invention likewise reflect an appreciation that known approaches to resolving the identity of multiple entities at a latter point in time, such as batch mode processing, are typically unable to resolve the identity of an entity prior to the performance of the next step of such processes.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a mobile device such as a tablet or smartphone, a consumer electronic device, a connected “smart device,” a network appliance, a network storage device, a network gateway device, a server or collection of servers or any other suitable device and may vary in size, shape, performance, functionality, and price. The information handling system may include volatile and/or non-volatile memory, and one or more processing resources such as a central processing unit (CPU) or hardware or software control logic. Additional components of the information handling system may include one or more storage systems, one or more wired or wireless interfaces for communicating with other networked devices, external devices, and various input and output (I/O) devices, such as a keyboard, a mouse, a microphone, speakers, a track pad, a touchscreen and a display device (including a touch sensitive display device). The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or solid state drive), a sequential access storage device (e.g., a tape disk drive), optical storage device, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

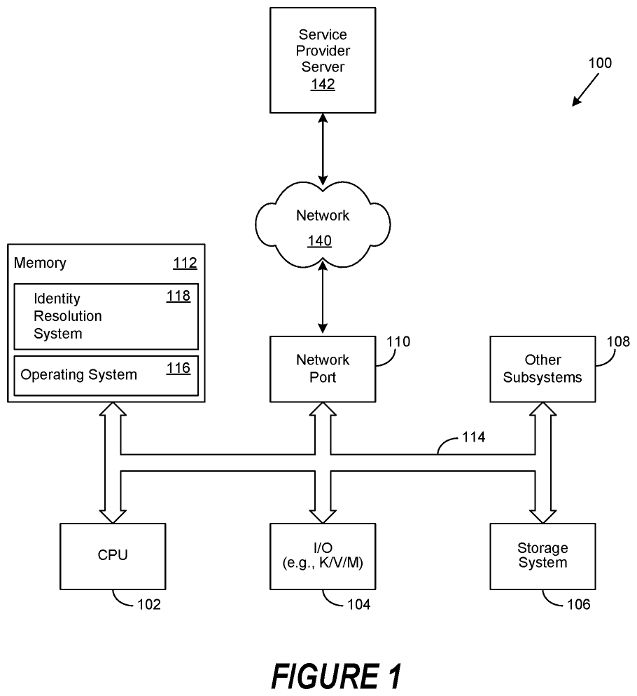

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a storage system 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further includes operating system (OS) 116 and in various embodiments may also include an identity resolution system 118. In one embodiment, the information handling system 100 is able to download the identity resolution system 118 from the service provider server 142. In another embodiment, the identity resolution system 118 is provided as a service from the service provider server 142.

In various embodiments, the identity resolution system 118 performs one or more operations for providing real-time resolution of the identity of an entity at a particular point in time. In certain embodiments, the real-time resolution of the identity of an entity at a particular point in time improves processor efficiency, and thus the efficiency of the information handling system 100, by automating the providing real-time resolution of the identity of an entity at a particular point in time. As will be appreciated, once the information handling system 100 is configured to provide real-time resolution of the identity of an entity at a particular point in time, the information handling system 100 becomes a specialized computing device specifically configured to provide real-time resolution of the identity of an entity at a particular point in time and is not a general purpose computing device. Moreover, the implementation of the identity resolution system 118 on the information handling system 100 improves the functionality of the information handling system 100 and provides a useful and concrete result of automating the real-time resolution of the identity of an entity at a particular point in time.

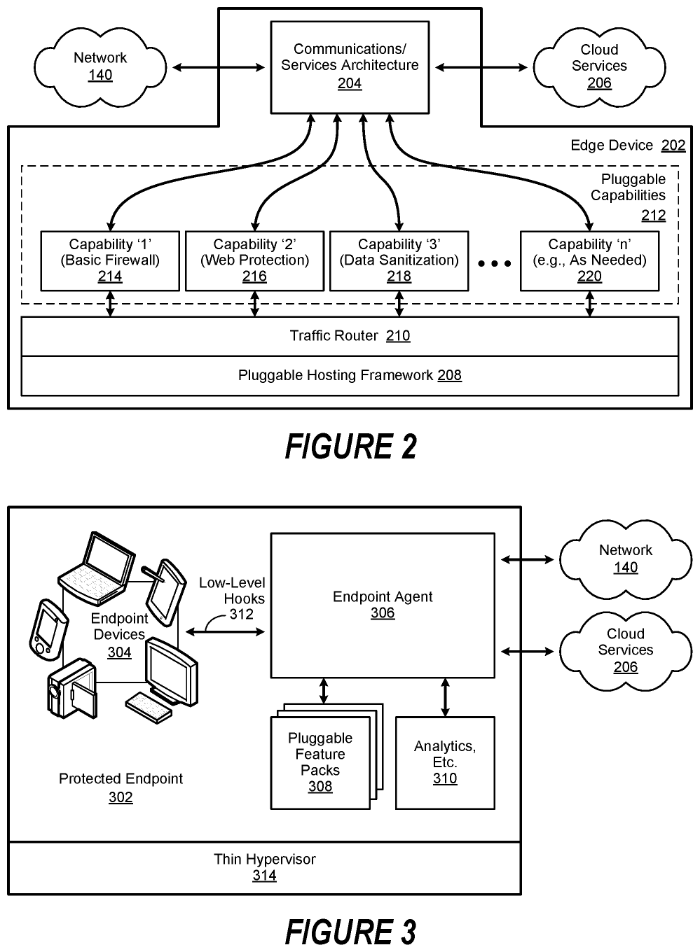

FIG. 2 is a simplified block diagram of an edge device implemented in accordance with an embodiment of the invention. As used herein, an edge device, such as the edge device 202 shown in FIG. 2, broadly refers to a device providing an entry point into a network 140. Examples of such edge devices 202 may include routers, routing switches, integrated access devices (IADs), multiplexers, wide-area network (WAN) access devices, and network security appliances. In certain embodiments, the network 140 may be a private network (e.g., an enterprise network), a semi-public network (e.g., a service provider core network), or a public network (e.g., the Internet).

Skilled practitioners of the art will be aware that edge devices 202 are often implemented as routers that provide authenticated access to faster, more efficient backbone and core networks. Furthermore, current industry trends include making edge devices 202 more intelligent, which allows core devices to operate at higher speed as they are not burdened with additional administrative overhead. Accordingly, such edge devices 202 often include Quality of Service (QoS) and multi-service functions to manage different types of traffic. Consequently, it is common to design core networks with switches that use routing protocols such as Open Shortest Path First (OSPF) or Multiprotocol Label Switching (MPLS) for reliability and scalability. Such approaches allow edge devices 202 to have redundant links to the core network, which not only provides improved reliability, but enables enhanced, flexible, and scalable security capabilities as well.

In certain embodiments, the edge device 202 may be implemented to include a communications/services architecture 204, various pluggable capabilities 212, a traffic router 210, and a pluggable hosting framework 208. In certain embodiments, the communications/services architecture 202 may be implemented to provide access to and from various networks 140, cloud services 206, or a combination thereof In certain embodiments, the cloud services 206 may be provided by a cloud infrastructure familiar to those of skill in the art. In certain embodiments, the edge device 202 may be implemented to provide support for a variety of generic services, such as directory integration, logging interfaces, update services, and bidirectional risk/context flows associated with various analytics. In certain embodiments, the edge device 202 may be implemented to provide temporal information, described in greater detail herein, associated with the provision of such services.

In certain embodiments, the edge device 202 may be implemented as a generic device configured to host various network communications, data processing, and security management capabilities. In certain embodiments, the pluggable hosting framework 208 may be implemented to host such capabilities in the form of pluggable capabilities 212. In certain embodiments, the pluggable capabilities 212 may include capability ‘1’ 214 (e.g., basic firewall), capability ‘2’ 216 (e.g., general web protection), capability ‘3’ 218 (e.g., data sanitization), and so forth through capability ‘n’ 220, which may include capabilities needed for a particular operation, process, or requirement on an as-needed basis. In certain embodiments, such capabilities may include the performance of operations associated with providing real-time resolution of the identity of an entity at a particular point in time. In certain embodiments, such operations may include the provision of associated temporal information (e.g., time stamps).

In certain embodiments, the pluggable capabilities 212 may be sourced from various cloud services 206. In certain embodiments, the pluggable hosting framework 208 may be implemented to provide certain computing and communication infrastructure components, and foundation capabilities, required by one or more of the pluggable capabilities 212. In certain embodiments, the pluggable hosting framework 208 may be implemented to allow the pluggable capabilities 212 to be dynamically invoked. Skilled practitioners of the art will recognize that many such embodiments are possible. Accordingly, the foregoing is not intended to limit the spirit, scope or intent of the invention.

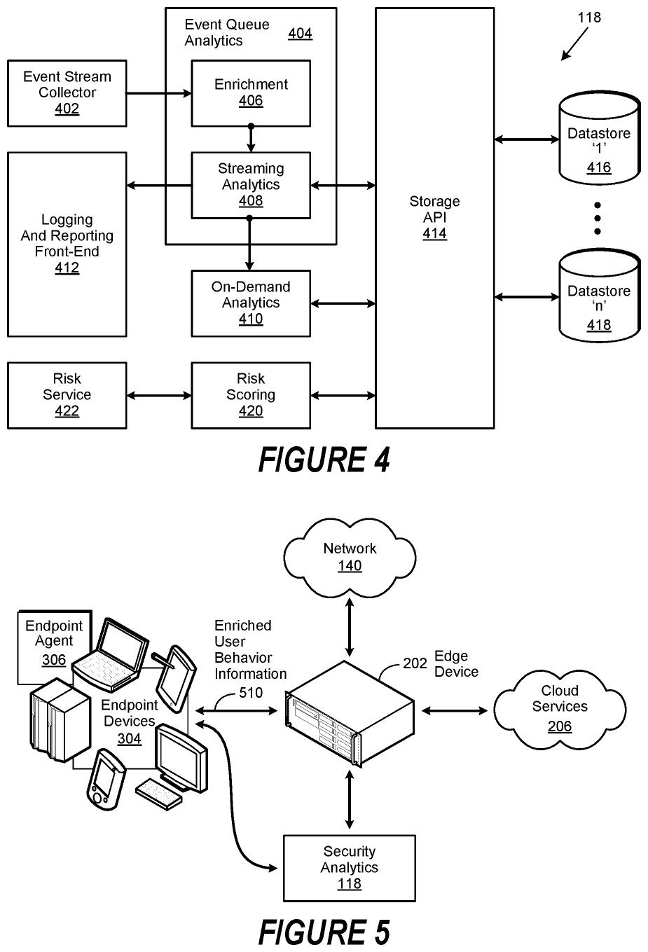

FIG. 3 is a simplified block diagram of an endpoint agent implemented in accordance with an embodiment of the invention. As used herein, an endpoint agent 306 broadly refers to a software agent used in combination with an endpoint device 304 to establish a protected endpoint 302. Skilled practitioners of the art will be familiar with software agents, which are computer programs that perform actions on behalf of a user or another program. In various approaches, a software agent may be autonomous or work together with another agent or a user. In certain of these approaches the software agent is implemented to autonomously decide if a particular action is appropriate for a given event, such as an observed user behavior.

An endpoint device 304, as likewise used herein, refers to an information processing system such as a personal computer, a laptop computer, a tablet computer, a personal digital assistant (PDA), a smart phone, a mobile telephone, a digital camera, a video camera, or other device that is capable of storing, processing and communicating data. In certain embodiments, the communication of the data may take place in real-time or near-real-time. As used herein, real-time broadly refers to processing and providing information within a time interval brief enough to not be discernable by a user. As an example, a cellular phone conversation may be used to communicate information in real-time, while an instant message (IM) exchange may be used to communicate information in near real-time. In certain embodiments, the communication of the information may take place asynchronously. For example, an email message may be stored on an endpoint device 304 when it is offline. In this example, the information may be communicated to its intended recipient once the endpoint device 304 gains access to a network 140.

A protected endpoint 302, as likewise used herein, broadly refers to a policy-based approach to network security that typically requires endpoint devices 304 to comply with particular criteria before they are granted access to network resources. As an example, a given endpoint device 304 may be required to have a particular operating system (OS), or version thereof, a Virtual Private Network (VPN) client, anti-virus software with current updates, and so forth. In certain embodiments, the protected endpoint 302 may be implemented to perform operations associated with providing real-time resolution of the identity of an entity at a particular point in time, as described in greater detail herein. In certain embodiments, the protected endpoint 302 may be implemented to provide temporal information, such as timestamp information, associated with such operations.

In certain embodiments, the real-time resolution of the identity of an entity at a particular point in time may be based upon contextual information associated with a given user behavior. As used herein, contextual information broadly refers to any information, directly or indirectly, individually or in combination, related to a particular user behavior. In certain embodiments, user behavior may include a user's physical behavior, cyber behavior, or a combination thereof. As likewise used herein, physical behavior broadly refers to any user behavior occurring within a physical realm. More particularly, physical behavior may include any action enacted by a user that can be objectively observed, or indirectly inferred, within a physical realm.

As an example, a user may attempt to use an electronic access card to enter a secured building at a certain time. In this example, the use of the access card to enter the building is the action and the reading of the access card makes the user's physical behavior electronically-observable. As another example, a first user may physically transfer a document to a second user, which is captured by a video surveillance system. In this example, the physical transferal of the document from the first user to the second user is the action. Likewise, the video record of the transferal makes the first and second user's physical behavior electronically-observable. As used herein, electronically-observable user behavior broadly refers to any behavior exhibited or enacted by a user that can be electronically observed.

Cyber behavior, as used herein, broadly refers to any behavior occurring in cyberspace, whether enacted by an individual user, a group of users, or a system acting at the behest of an individual user, a group of users, or an entity. More particularly, cyber behavior may include physical, social, or mental actions that can be objectively observed, or indirectly inferred, within cyberspace. As an example, a user may use an endpoint device 304 to access and browse a particular website on the Internet. In this example, the individual actions performed by the user to access and browse the website constitute a cyber behavior. As another example, a user may use an endpoint device 304 to download a data file from a particular system at a particular point in time. In this example, the individual actions performed by the user to download the data file, and associated temporal information, such as a time-stamp associated with the download, constitute a cyber behavior. In these examples, the actions are enacted within cyberspace, in combination with associated temporal information, makes them electronically-observable.

As likewise used herein, cyberspace broadly refers to a network 140 environment capable of supporting communication between two or more entities. In certain embodiments, the entity may be a user, an endpoint device 304, or various resources, described in greater detail herein. In certain embodiments, the entities may include various endpoint devices 304 or resources operating at the behest of an entity, such as a user. In certain embodiments, the communication between the entities may include audio, image, video, text, or binary data.

As described in greater detail herein, the contextual information may include a user's authentication factors. Contextual information may likewise include various temporal identity resolution factors, such as identification factors associated with the user, the date/time/frequency of various user behaviors, the user's location, the user's role or position in an organization, their associated access rights, and certain user gestures employed by the user in the enactment of a user behavior. Other contextual information may likewise include various user interactions, whether the interactions are with an endpoint device 304, a network 140, a resource, or another user. In certain embodiments, user behaviors, and their related contextual information, may be collected at particular points of observation, and at particular points in time, described in greater detail herein.

In certain embodiments, the endpoint agent 306 may be implemented to universally support a variety of operating systems, such as Apple Macintosh®, Microsoft Windows®, Linux®, Android® and so forth. In certain embodiments, the endpoint agent 306 may be implemented to interact with the endpoint device 304 through the use of low-level hooks 312 at the OS level. It will be appreciated that the use of low-level hooks 312 allows the endpoint agent 306 to subscribe to multiple events through a single hook. Consequently, multiple functionalities provided by the endpoint agent 306 can share a single data stream, using only those portions of the data stream they may individually need. Accordingly, system efficiency can be improved and operational overhead reduced.

In certain embodiments, the endpoint agent 306 may be implemented to provide a common infrastructure for pluggable feature packs 308. In various embodiments, the pluggable feature packs 308 may provide certain security management functionalities. Examples of such functionalities may include various anti-virus and malware detection, data loss protection (DLP), insider threat detection, and so forth. In certain embodiments, the security management functionalities may include one or more functionalities associated with providing real-time resolution of the identity of an entity at a particular point in time, as described in greater detail herein.

In certain embodiments, a particular pluggable feature pack 308 is invoked as needed by the endpoint agent 306 to provide a given functionality. In certain embodiments, individual features of a particular pluggable feature pack 308 are invoked as needed. It will be appreciated that the ability to invoke individual features of a pluggable feature pack 308, without necessarily invoking all such features, will likely improve the operational efficiency of the endpoint agent 306 while simultaneously reducing operational overhead. Accordingly, the endpoint agent 306 can self-optimize in certain embodiments by using the common infrastructure and invoking only those pluggable components that are applicable or needed for a given user behavior.

In certain embodiments, the individual features of a pluggable feature pack 308 are invoked by the endpoint agent 306 according to the occurrence of a particular user behavior. In certain embodiments, the individual features of a pluggable feature pack 308 are invoked by the endpoint agent 306 according to the occurrence of a particular temporal event, described in greater detail herein. In certain embodiments, the individual features of a pluggable feature pack 308 are invoked by the endpoint agent 306 at a particular point in time. In these embodiments, the method by which a given user behavior, temporal event, or point in time is selected is a matter of design choice.

In certain embodiments, the individual features of a pluggable feature pack 308 may be invoked by the endpoint agent 306 according to the context of a particular user behavior. As an example, the context may be the user enacting the user behavior, their associated risk classification, which resource they may be requesting, the point in time the user behavior is enacted, and so forth. In certain embodiments, the pluggable feature packs 308 may be sourced from various cloud services 206. In certain embodiments, the pluggable feature packs 308 may be dynamically sourced from various cloud services 206 by the endpoint agent 306 on an as-need basis.

In certain embodiments, the endpoint agent 306 may be implemented with additional functionalities, such as event analytics 310. In certain embodiments, the event analytics 310 functionality may include analysis of various user behaviors, described in greater detail herein. In certain embodiments, the endpoint agent 306 may be implemented with a thin hypervisor 314, which can be run at Ring-1, thereby providing protection for the endpoint agent 306 in the event of a breach. As used herein, a thin hypervisor broadly refers to a simplified, OS-dependent hypervisor implemented to increase security. As likewise used herein, Ring-1 broadly refers to approaches allowing guest operating systems to run Ring 0 (i.e., kernel) operations without affecting other guests or the host OS. Those of skill in the art will recognize that many such embodiments and examples are possible. Accordingly, the foregoing is not intended to limit the spirit, scope or intent of the invention.

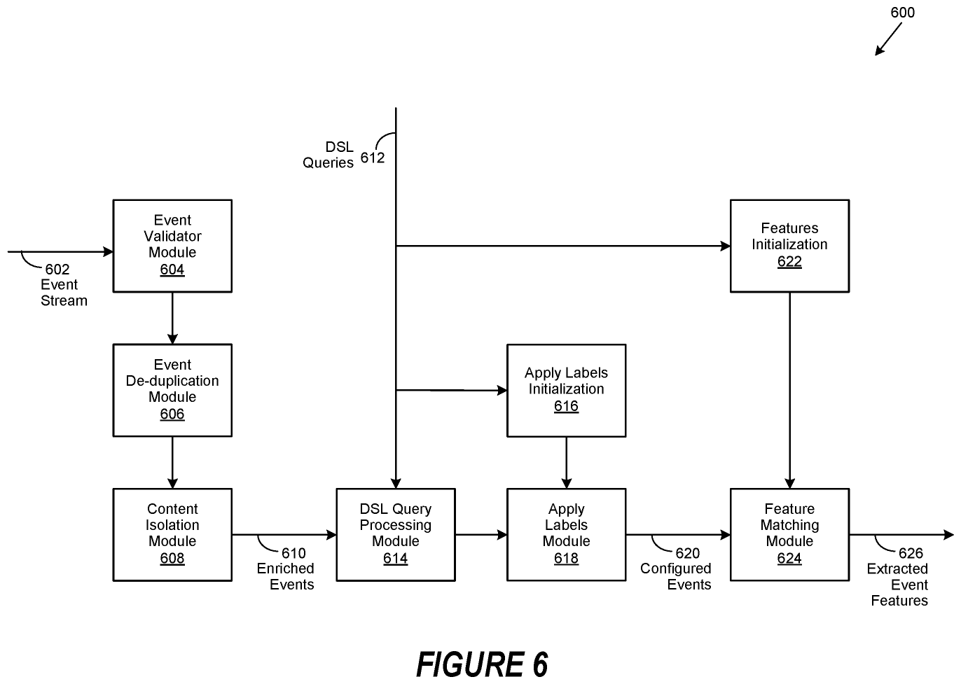

FIG. 4 is a simplified block diagram of a security analytics system implemented in accordance with an embodiment of the invention. In certain embodiments, the security analytics system shown in FIG. 4 may be implemented to provide log storage, reporting, and analytics capable of performing streaming 406 and on-demand 408 analytics operations. In certain embodiments, such operations may be associated with providing real-time resolution of the identity of an entity at a particular point in time, as described in greater detail herein. In certain embodiments, the security analytics system may be implemented to provide a uniform platform for storing events and contextual information associated with various user behaviors and performing longitudinal analytics.

As used herein, longitudinal analytics broadly refers to performing analytics of user behaviors occurring over a particular period of time. As an example, a user may iteratively attempt to access certain proprietary information stored in various locations. In addition, the attempts may occur over a brief period of time. To continue the example, the fact that the information the user is attempting to access is proprietary, that it is stored in various locations, and the attempts are occurring in a brief period of time, in combination, may indicate the user behavior enacted by the user is suspicious. As another example, certain entity identifier information (e.g., a user name) associated with a user may change over time. In this example, the change in user name, during a particular time period or at a particular point in time, may represent suspicious user behavior.

In certain embodiments, the security analytics system may be implemented to be scalable. In one embodiment, the security analytics system may be implemented in a centralized location, such as a corporate data center. In this embodiment, additional resources may be added to the security analytics system as needs grow. In another embodiment, the security analytics system may be implemented as a distributed system. In this embodiment, the security analytics system may span multiple information processing systems. In yet another embodiment, the security analytics system may be implemented in a cloud environment. In yet still another embodiment, the security analytics system may be implemented in a virtual machine (VM) environment. In such an embodiment, the VM environment may be configured to dynamically and seamlessly scale the security analytics system as needed. Skilled practitioners of the art will recognize that many such embodiments are possible. Accordingly, the foregoing is not intended to limit the spirit, scope or intent of the invention.

In certain embodiments, an event collector 402 may be implemented to collect event and contextual information, described in greater detail herein, associated with various user behaviors. In these embodiments, the method by which the event and contextual information collected by the event collector 402 is selected to be collected is a matter of design choice. In certain embodiments, the event and contextual information collected by the event collector 402 may be processed by an enrichment module 404 to generate enriched user behavior information. In certain embodiments, the enrichment may include certain contextual information related to a particular user behavior. In certain embodiments, the enrichment may include certain temporal information, such as timestamp information, related to a particular user behavior.

In certain embodiments, enriched user behavior information may be provided by the enrichment module 404 to a streaming 406 analytics module. In turn, the streaming 406 analytics module may provide some or all of the enriched user behavior information to an on-demand 408 analytics module. As used herein, streaming 406 analytics broadly refers to analytics performed in near real-time on enriched user behavior information as it is received. Likewise, on-demand 408 analytics broadly refers herein to analytics performed, as it is requested, on enriched user behavior information after it has been received.

In one embodiment, the on-demand 408 analytics may be performed on enriched user behavior associated with a particular interval of, or point in, time. In another embodiment, the streaming 406 or on-demand 408 analytics may be performed on enriched user behavior associated with a particular user, group of users, one or more entities, or a combination thereof In yet another embodiment, the streaming 406 or on-demand 408 analytics may be performed on enriched user behavior associated with a particular resource, such as a facility, system, datastore, or service. Those of skill in the art will recognize that many such embodiments are possible. Accordingly, the foregoing is not intended to limit the spirit, scope or intent of the invention.

In certain embodiments, the results of various analytics operations performed by the streaming 406 or on-demand 408 analytics modules may be provided to a storage Application Program Interface (API) 412. In turn, the storage API 412 may be implemented to provide access to various datastores ‘1’ 414 through ‘n’ 416, which in turn are used to store the results of the analytics operations. In certain embodiments, the security analytics system may be implemented with a logging and reporting front-end 410, which is used to receive the results of analytics operations performed by the streaming 406 analytics module. In certain embodiments, the datastores ‘1’ 414 through ‘n’ 416 may variously include a datastore of entity identifiers, temporal events, or a combination thereof.

In certain embodiments, the security analytics system may be implemented to provide a risk management service 418. In certain embodiments, the risk management service 418 may be implemented to perform operations associated with providing real-time resolution of the identity of an entity at a particular point in time, as described in greater detail herein. In certain embodiments, the risk management service 418 may be implemented to provide the results of various analytics operations performed by the streaming 406 or on-demand 408 analytics modules. In certain embodiments, the risk management service 418 may be implemented to use the storage API 412 to access various enhanced cyber behavior and analytics information stored on the datastores ‘1’ 414 through ‘n’ 416. Skilled practitioners of the art will recognize that many such embodiments are possible. Accordingly, the foregoing is not intended to limit the spirit, scope or intent of the invention.

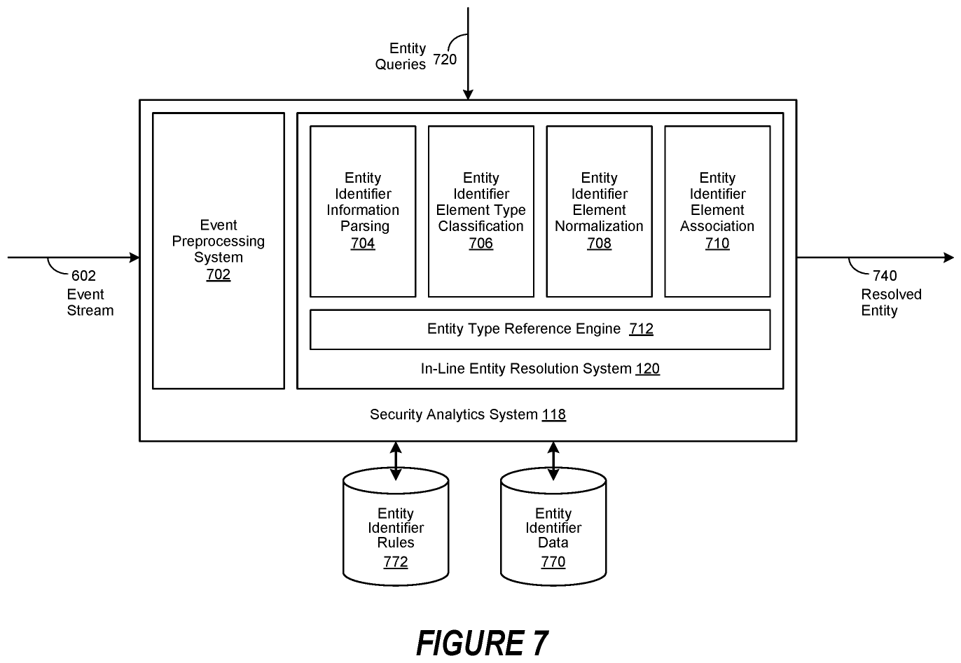

FIG. 5 is a simplified block diagram of the operation of a security analytics system implemented in accordance with an embodiment of the invention. In certain embodiments, the security analytics system 512 may be implemented to perform operations associated with providing real-time resolution of the identity of an entity at a particular point in time. In certain embodiments, the security analytics system 512 may be implemented in combination with one or more endpoint agents 306, one or more edge devices 202, cloud services 206, and a security analytics system 512, and a network 140 to perform such operations.

In certain embodiments, the network edge device 202 may be implemented in a bridge, a firewall, or a passive monitoring configuration. In certain embodiments, the edge device 202 may be implemented as software running on an information processing system. In certain embodiments, the network edge device 202 may be implemented to provide integrated logging, updating and control. In certain embodiments, the edge device 202 may be implemented to receive network requests and context-sensitive cyber behavior information in the form of enriched cyber behavior information 510, described in greater detail herein, from an endpoint agent 306, likewise described in greater detail herein.

In certain embodiments, the security analytics system 512 may be implemented as both a source and a sink of user behavior information. In certain embodiments, the security analytics system 512 may be implemented to serve requests for user/resource risk data. In certain embodiments, the edge device 202 and the endpoint agent 306, individually or in combination, may provide certain user behavior information to the security analytics system 512 using either push or pull approaches familiar to skilled practitioners of the art.

As described in greater detail herein, the edge device 202 may be implemented in certain embodiments to receive enriched user behavior information 510 from the endpoint agent 306. It will be appreciated that such enriched user behavior information 510 will likely not be available for provision to the edge device 202 when an endpoint agent 306 is not implemented for a corresponding endpoint device 304. However, the lack of such enriched user behavior information 510 may be accommodated in various embodiments, albeit with reduced functionality associated with operations associated with providing real-time resolution of the identity of an entity at a particular point in time.

In certain embodiments, a given user behavior may be enriched by an associated endpoint agent 306 attaching contextual information to a request. In one embodiment, the context is embedded within a network request, which is then provided as enriched user behavior information 510. In another embodiment, the contextual information is concatenated, or appended, to a request, which in turn is provided as enriched user behavior information 510. In these embodiments, the enriched user behavior information 510 is unpacked upon receipt and parsed to separate the request and its associated contextual information. Those of skill in the art will recognize that one possible disadvantage of such an approach is that it may perturb certain Intrusion Detection System and/or Intrusion Detection Prevention (IDS/IDP) systems implemented on a network 140.

In certain embodiments, new flow requests are accompanied by a contextual information packet sent to the edge device 202. In these embodiments, the new flow requests may be provided as enriched user behavior information 510. In certain embodiments, the endpoint agent 306 may also send updated contextual information to the edge device 202 once it becomes available. As an example, an endpoint agent 306 may share a list of files that have been read by a current process at any point in time once the information has been collected. To continue the example, such a list of files may be used to determine which data the endpoint agent 306 may be attempting to exfiltrate.

In certain embodiments, point analytics processes executing on the edge device 202 may request a particular service. As an example, risk scores on a per-user basis may be requested. In certain embodiments, the service may be requested from the security analytics system 512. In certain embodiments, the service may be requested from various cloud services 206.

In certain embodiments, contextual information associated with a user behavior may be attached to various network service requests. In certain embodiments, the request may be wrapped and then handled by proxy. In certain embodiments, a small packet of contextual information associated with a user behavior may be sent with a service request. In certain embodiments, service requests may be related to Domain Name Service (DNS), web, email, and so forth, all of which are essentially requests for service by an endpoint device 304. In certain embodiments, such service requests may be associated with temporal event information, described in greater detail herein. Consequently, such requests can be enriched by the addition of user behavior contextual information (e.g., UserAccount, interactive/automated, data-touched, temporal event information, etc.). Accordingly, the edge device 202 can then use this information to manage the appropriate response to submitted requests. In certain embodiments, such requests may be associated with providing real-time resolution of the identity of an entity at a particular point in time.

In certain embodiments, the security analytics system 512 may be implemented in different operational configurations. In one embodiment, the security analytics system 512 may be implemented by using the endpoint agent 306. In another embodiment, the security analytics system 512 may be implemented by using endpoint agent 306 in combination with the edge device 202. In certain embodiments, the cloud services 206 may likewise be implemented for use by the endpoint agent 306, the edge device 202, and the security analytics system 512, individually or in combination. In these embodiments, the security analytics system 512 may be primarily oriented to performing risk assessment operations related to user actions, program actions, data accesses, or a combination thereof In certain embodiments, program actions may be treated as a proxy for the user.

In certain embodiments, the endpoint agent 306 may be implemented to update the security analytics system 512 with user behavior and associated contextual information, thereby allowing an offload of certain analytics processing overhead. In one embodiment, this approach allows for longitudinal risk scoring, which assesses risk associated with certain user behavior during a particular interval of time. In another embodiment, the security analytics system 512 may be implemented to allow the risk-adaptive behavior system to access risk scores associated with the same user account, but accrued on different endpoint devices 304. It will be appreciated that such an approach may prove advantageous when an adversary is “moving sideways” through a network environment, using different endpoint devices 304 to collect information.

In certain embodiments, the security analytics system 512 may be primarily oriented to applying risk mitigations in a way that maximizes security effort return-on-investment (ROI). In certain embodiments, the approach may be accomplished by providing additional contextual and user behavior information associated with user requests. As an example, a web gateway may not concern itself with why a particular file is being requested by a certain entity at a particular point in time. Accordingly, if the file cannot be identified as malicious or harmless, there is no context available to determine how, or if, to proceed.

To extend the example, the edge device 202 and security analytics system 512 may be coupled such that requests can be contextualized and fitted into a framework that evaluates their associated risk. It will be appreciated that such an embodiment works well with web-based data loss protection (DLP) approaches, as each transfer is no longer examined in isolation, but in the broader context of an identified user's actions, at a particular time, on the network 140.

As another example, the security analytics system 512 may be implemented to perform risk scoring processes to decide whether to block or allow unusual flows. It will be appreciated that such an approach is highly applicable to defending against point-of-sale (POS) malware, a breach technique that has become increasingly more common in recent years. It will likewise be appreciated that while various edge device 202 implementations may not stop all such exfiltrations, they may be able to complicate the task for the attacker.

In certain embodiments, the security analytics system 512 may be primarily oriented to maximally leverage contextual information associated with various user behaviors within the system. In certain embodiments, data flow tracking is performed by one or more endpoint agents 306, which allows the quantity and type of information associated with particular hosts to be measured. In turn, this information may be used to determine how the edge device 202 handles requests. By contextualizing such user behavior on the network 140, the risk-adaptive behavior system can provide intelligent protection, making decisions that make sense in the broader context of an organization's activities. It will be appreciated that one advantage to such an approach is that information flowing through an organization, and the networks they employ, should be trackable, and substantial data breaches preventable. Skilled practitioners of the art will recognize that many such embodiments and examples are possible. Accordingly, the foregoing is not intended to limit the spirit, scope or intent of the invention.

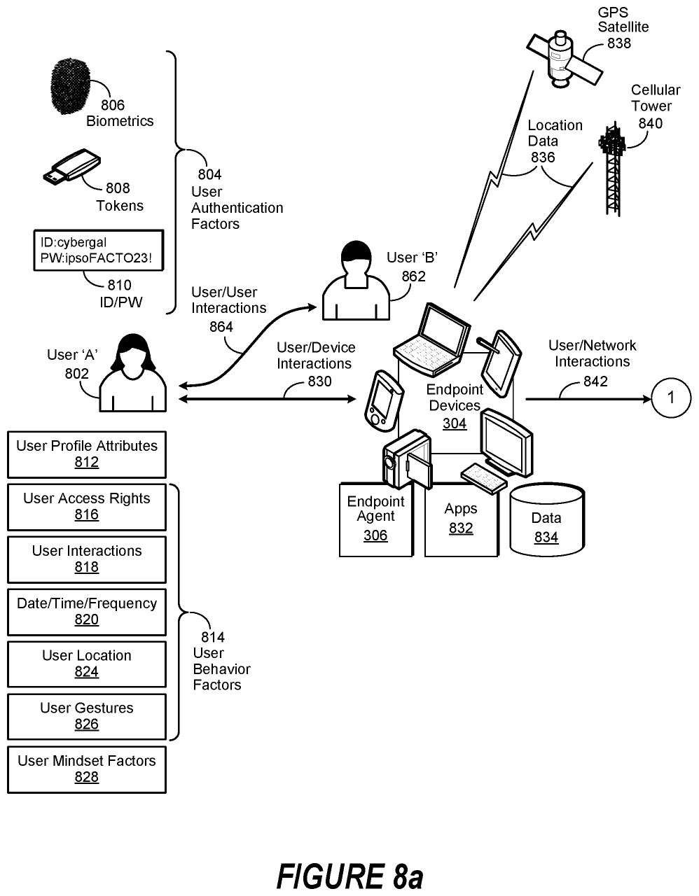

FIG. 6 is a generalized process flow diagram of the performance of event preprocessing operations implemented in accordance with an embodiment of the invention. As used herein, an event broadly refers to the occurrence of an action performed by an entity. In certain embodiments, the action may be directly associated with a user behavior, described in greater detail herein. As an example, a first user may attach a binary file infected with a virus to an email that is subsequently sent to a second user. In this example, the act of attaching the binary file to the email is directly associated with a user behavior enacted by the first user. In certain embodiments, the action may be indirectly associated with a user behavior. To continue the example, the recipient of the email may open the infected binary file, and as a result, infect their computer with malware. To further continue the example, the act of opening the infected binary file is directly associated with a user behavior enacted by the second user. However, the infection of the email recipient's computer by the infected binary file is indirectly associated with the described user behavior enacted by the second user.

As likewise used herein, an entity broadly refers to something that exists as itself, whether physically or abstractly. In certain embodiments, an entity may be an individual user, a group, an organization, or a government. In certain embodiments, an entity may likewise be an item, a device, such as endpoint and edge devices, a network, a domain, an operation, or a process. In certain embodiments, an entity may be a resource, such as a geographical location or formation, a physical facility, a venue, a system, a data store, or a service, such as a service operating in a cloud environment.

In certain embodiments, event preprocessing operations 600 may be initiated by individual events in an event stream 602 being received and processed by various event enrichment modules, to generate enriched events 610. In certain embodiments, these modules may include an event validator 604 module, an event de-duplication 606 module, and a content isolation 608 module, or a combination thereof. As used herein, event enrichment broadly refers to performing certain data enrichment operations and processes associated with enriching data associated with a particular event in the event stream 602. As likewise used herein, data enrichment broadly refers to various operations and processes typically used to enhance, refine or otherwise improve raw data.

Examples of geographic data enrichment may include the use of postal code, county name, longitude and latitude, and political district data, while examples of behavioral data enrichment may include purchase, credit risk, and preferred communication channel data. Likewise, examples of demographic data enrichment may include the use of income, marital status, and education data, while examples of psychographic data enrichment may include interests and political affiliation data.

In certain embodiments, event enrichment may include matching certain incoming events in the event stream 602 with existing event data. In certain embodiments, event enrichment may include deleting certain data associated with certain incoming events in the event stream 602. For example, certain data associated with various incoming events may be determined to be irrelevant to analyzing the probability distributions of certain interrelated event features. In certain embodiments, the method by which data associated with various incoming events is determined to be irrelevant is a matter of design choice.

In certain embodiments, event enrichment may include correcting invalid data associated with certain incoming events in the event stream 602. In certain embodiments, event enrichment may include interpolating data associated with certain incoming events in the event stream 602 with existing event data. In certain embodiments, the existing event data may be stored in a repository of persistent event data.

For example, an event in the event stream 602 may be associated with a first user attaching a binary file to an email addressed to a second user. In this example, the event enrichment operations 600 may include determining the file type of the attachment. Likewise, the event preprocessing operations 600 may include determining the size of the attachment, the date and time of the email, the address of the originating email server, the email addresses of the first and second user, and so forth. In certain embodiments, the event preprocessing operations 600 may include associating annotations or other metadata corresponding to such determinations with the event.

In certain embodiments, the event enrichment modules may include an event validator module 604. In certain embodiments, the event validator 604 module may be implemented to perform data validation operations on data associated with a particular event. As used herein, data validation broadly refers to various operations and processes associated with data cleansing to ensure data quality. As likewise used herein, data cleansing broadly refers to the process of detecting, correcting, and possible removing, corrupted or inaccurate elements from a data set. In certain embodiments, data cleansing operations may include identifying incomplete, incorrect, inaccurate, or irrelevant data elements and then replacing, modifying or deleting certain data elements that fail to meet certain data use parameters.

In certain embodiments, the event validator 604 module may be implemented to perform data validation operations without the use of statistical data. In certain embodiments, the event validator 604 module may be implemented to validate event timestamps falling within a particular interval of time. In certain embodiments, the interval of time may be user-defined or otherwise configurable. In these embodiments, the definition of the interval of time is a matter of design choice. In certain embodiments, the event validator 604 module may be implemented such that an alias for an entity does not exceed a certain number of characters. In these embodiments, the number of characters is a matter of design choice. In certain embodiments, the event validator 604 module may be implemented that any attested metadata has an expected, corresponding type. In these embodiments, the expected type of metadata is a matter of design choice.

In certain embodiments, the resulting validated event data may be consistent with similar data sets used by a security analytics system to analyze the probability distribution of features associated with certain interrelated events. Certain embodiments of the invention reflect an appreciation that the intent of such data validation is to ensure fitness, accuracy and consistency of data associated with a particular event.

In certain embodiments, the event de-duplication 606 module may be implemented to perform operations associated with de-duplication, entity resolution, attachment enrichment, domain enrichment, or some combination thereof. As used herein, de-duplication operations broadly refer to operations for determining a unique identity for an event based upon certain identifying fields. In certain embodiments, the identifying fields may include an externally-generated concept, idea or notion provided by the data source from which the event originated. In various embodiments, the identifying fields may include certain fields deemed to be fundamental to the identity of an event, or identification thereof. In certain embodiments, the value of an identifying field may be taken as imprecise with configurable granularity. For example, events that appear to be similar, and have timestamps within one minute of one another, may be considered duplicates.

As likewise used herein, entity resolution operations broadly refer to operations for resolving certain raw identifiers in input data to known entities. Likewise, as used herein, attachment enrichment operations broadly refer to operations for adding metadata based upon the quantity or type of data associated with an event. In certain embodiments, the metadata may be determined by extension, mime type headers, or mime type, as inferred from content associated with an event. In certain embodiments, the metadata may be internal or external to an organization, a particular business unit, government agency, and so forth. Domain enrichment operations, as likewise used herein, broadly refers to operations for adding metadata based upon a particular realm of Internet administrative autonomy, authority, or control associated with an event.

In certain embodiments, the content isolation 608 module may be implemented to recognize and isolate certain types of recurring content. Examples of such recurring content may include standardized text, such as disclaimers or various types of boilerplate. Other examples of recurring content may include graphical images such as logos, icons, user avatars, and so forth.

In certain embodiments, the event preprocessing operations 600 may include the processing of Domain Specific Language queries 612. As used herein, a Domain Specific Language (DSL) broadly refers to a computer language specialized to a particular application domain. Examples of DSLs include Hypertext Mark-up Language (HTML) for web pages. Mathematica® for symbolic mathematics, Structured Query Language (SQL) for relational database queries, and Query DSL (QDSL) for Elasticsearch queries.

In certain embodiments, a DSL query processing 614 module may be implemented to process various DSL queries 612. In certain embodiments, the DSL query 612 may reference data, metadata, or a combination thereof, related to an event. In certain embodiments, the DSL query 612 may be expressed in a DSL specific to the domain of events involving the data, metadata, or a combination thereof, related to such events. In certain embodiments, the DSL query processing 614 module may be implemented to receive enriched events 610 resulting from performance of the event enrichment operations described in greater detail herein.

In certain embodiments, the DSL query processing 614 module may be implemented to determine whether or not a particular document matches a set of DSL queries 612. As used herein, a document broadly refers to a body of content. In certain embodiments, such content may include text, unstructured data, structured data, graphical images, photographs, audio recordings, video recordings, biometric information, metadata, and so forth.

In certain embodiments, the DSL query processing 614 module may be implemented to provide a streaming query framework. In certain embodiments, the streaming query framework may be implemented to extract features in real-time, in batch mode, or on-demand. As used herein, a feature, as it relates to an event, broadly refers to a property, characteristic or attribute of a particular event. As an example, features associated with a corpus of thousands of text-oriented messages (e.g., SMS, email, social network messages, etc.) may be generated by removing low-value words (i.e., stopwords), using certain size blocks of words (i.e., n-grams), or applying various text processing rules. Examples of features associated with an event may include the number of bytes uploaded, the time of day, the presence of certain terms in unstructured content, the respective domains associated with senders and recipients of information, and the Uniform Resource Locator (URL) classification of certain web page visits. Examples of other features associated with an event may include data associated with various risk-adaptive behavior factors, described in greater detail herein.

In certain embodiments, such features may be associated with anomalous, abnormal, unexpected or malicious user behavior, as described in greater detail herein. In certain embodiments, the occurrence of an unlikely feature or features associated with a particular entity may result in the generation of a corresponding risk score. In certain embodiments, the generation of a corresponding risk score may include computing the aggregation of occurrences of certain unlikely features with which an entity may be associated. In certain embodiments, the resulting risk score may be assigned, or otherwise associated, with the entity associated with the occurrence of an unlikely feature. In certain embodiments, the assigned risk score may be implemented to reflect a security risk corresponding to the entity associated with the occurrence of the unlikely feature. In certain embodiments, multiple occurrences of an unlikely feature within a particular period of time may increase an assigned risk score.

In certain embodiments, the DSL query processing 614 module may be implemented to receive certain DSL queries 612 that include terms, features, tags, or other items of interest that may be associated with certain interrelated events. As used herein, a term broadly refers to a word, compound word, phrase expression, numeric value, or alphanumeric string, which in certain contexts is associated with a particular meaning. As used herein, a phrase broadly refers to a sequence of terms, or multi-words, familiar to skilled practitioners of the art. In certain embodiments, a term may be associated with an event, a feature of an event, a classification label, a metadata tag label, or a combination thereof.

In certain embodiments, the DSL query processing 614 module may be implemented to determine the commonalities between such DSL queries 612. In certain embodiments, the DSL query processing 614 module may be implemented only evaluate the features or other terms of interest needed for the evaluation of a particular event. In certain embodiments, the DSL query processing 614 module may be implemented to only evaluate the features or other terms of interest once when processing multiple DSL queries 612.

In certain embodiments, the DSL queries 612 may only be processed when the DSL query processing 614 module is first initialized. In certain embodiments the DSL queries 612 may be reprocessed periodically by the DSL query processing 614 module during event collection if they have been added to or otherwise changed. In certain embodiments, such reprocessing may be performed by periodically polling for configuration changes and reinitializing the DSL query processing 614 module as needed. Certain embodiments of the invention reflect an appreciation that such reinitializing of the DSL query processing 614 module facilitates the reduction of a DSL query 612, which involves executing preliminary query steps against reference data (not shown).

As an example, a DSL query 612 may be for events associated with employees whose salary is greater than some amount. In this example, the first step is to identify who those employees may be, and once they are identified, include them into the query when it is “reduced.” It will be appreciated that the use of cached results in place of taking this step may result in missing an employee who recently received a raise, and as a result, belongs in the group of identified employees. It will likewise be appreciated that inclusion in the group of identified employees would typically not occur until the DSL query processing 614 module was reinitialized. In certain embodiments, the DSL query processing 614 module may be implemented to periodically recompile and re-reduce certain DSL queries 612. In these embodiments, the method by which the decision is made to periodically recompile and re-reduce DSL queries 612 is a matter of design choice.

In certain embodiments, the receipt of a DSL query 612 may result in certain apply labels initialization 616 operations being performed to initialize an apply labels 618 module. In certain embodiments, the apply labels 618 module may be implemented to classify events received from the DSL query processing 614 module by labeling them with associated classification labels to generate configured events 620. In certain embodiments, the labels applied by the apply labels 618 module may include associated metadata tags. In these embodiments, the method by which the apply labels 618 module selects a classification or metadata tag label, and the associated nomenclature thereof, is a matter of design choice.

As an example, an event may include a user downloading a file from a particular server address. In this example, the event may be classified as a “file download” with corresponding metadata of “server address.” Accordingly, the apply labels 618 module may apply both a “file download” classification label and a “server address” metadata tag label to the event. As another example, an event may include an employee using a badge to enter a secured facility after normal work hours. In this example, the event may be classified as “facility access,” with corresponding metadata of “secure” and “after hours.” Accordingly, the apply labels 618 module may apply a “facility access” classification label as well as “secure” and “after hours” metadata tag labels to the event.

In certain embodiments, the labels applied by the apply labels 618 module may be user-generated, user-edited, or a combination thereof. In various embodiments, certain labels applied by the apply labels 618 module may be applied automatically, corresponding to certain sets of conditions. In certain embodiments, the labels applied by the apply labels 618 module may be automatically or manually removed from certain interrelated events, based on inspection. In certain embodiments, the labels applied by the apply labels 618 module to one event may automatically or manually be added to another event. In certain embodiments, such addition of labels may be based upon a query to provide bulk labeling of certain interrelated events that may share common features or other characteristics. In various embodiments, such addition of labels may be implemented to flag certain interrelated events as part of a review workflow. In certain embodiments, the apply labels operations performed by the apply labels 618 module may result in configured features.

In certain embodiments, the receipt of a DSL query 612 may result in certain features initialization 622 operations being performed to initialize a feature matching 624 module. In certain embodiments, configured events 620 generated by the apply labels 618 module may be processed by the feature matching 624 module to generate matched features. In certain embodiments, the feature matching 624 module may be implemented to perform certain feature extraction operations on the configured features 620 generated by the apply labels 618 module.

As likewise used herein, feature extraction broadly refers to the selection of a subset of features associated with an event. In certain embodiments, the feature extraction operations performed by the feature matching 624 module may result in the generation of extracted event features 626, described in greater detail herein. In certain embodiments, the feature matching 624 module may be implemented to perform transformation operations on a group of features associated with an event to generate a smaller set of derived features. In certain embodiments, the determination of whether or not feature matching operations are performed may be dependent upon on the type of the feature. In certain embodiments, the type of the feature may be determined by an associated feature definition. In these embodiments, the method by which a feature definition is defined, determined, or associated with a corresponding feature is a matter of design choice.

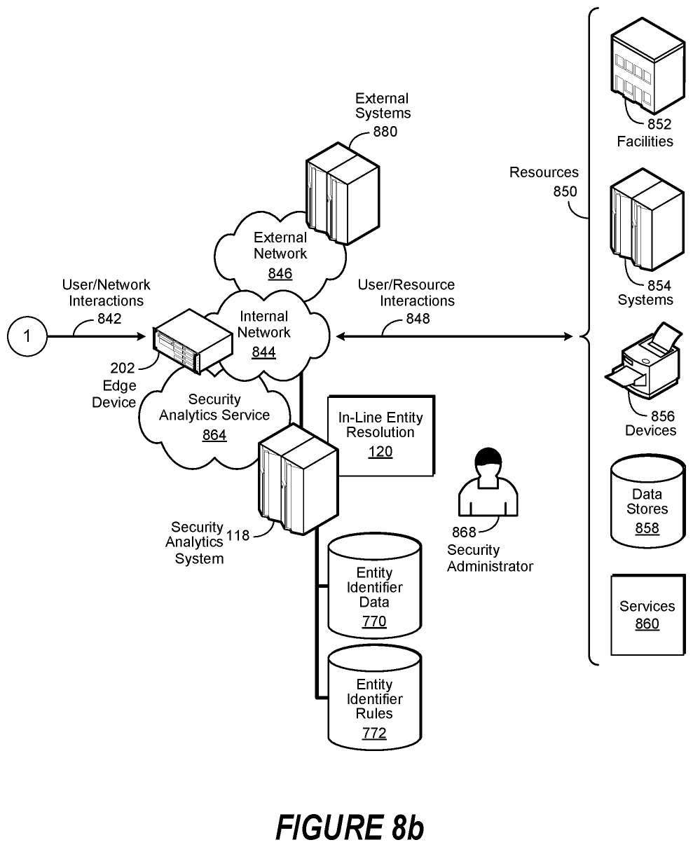

FIG. 7 is a simplified block diagram of an in-line entity resolution system implemented in accordance with an embodiment of the invention. In certain embodiments, a security analytics system 118 may be implemented to process certain entity information corresponding to an event to resolve the identity of an associated entity. As used herein, entity information broadly refers to information that can be used to ascertain or corroborate the identity of an entity and its associated behavior, whether the behavior occurs within a physical realm or cyberspace. In certain embodiments, entity information may include user profile attributes, user behavior factors, or user mindset factors, described in greater detail herein. In various embodiments, entity information may include certain types of content. In these embodiments, such content may include text, unstructured data, structured data, graphical images, photographs, audio recordings, video recordings, biometric information, and so forth. In certain embodiments, the entity information may include metadata. In certain embodiments, the metadata may include entity attributes, which in turn may include certain entity identifier types or classifications.

In various embodiments, the security analytics system 118 may be implemented to use certain entity identifier information to ascertain the identity of an associated entity at a particular point in time. As used herein, entity identifier information broadly refers to an information element associated with an entity that can be used to ascertain or corroborate the identity of its corresponding entity at a particular point in time. In certain embodiments, the entity identifier information may include user authentication factors, user profile attributes, user behavior factors, user mindset factors, information associated with various endpoint and edge devices, networks, resources, or a combination thereof.

In certain embodiments, the entity identifier information may include temporal information. As used herein, temporal information broadly refers to a particular point in time (e.g., a date, timestamp, etc.), a measure of time (e.g., a minute, hour, day, etc.), or an interval of time (e.g., between Jun. 3, 2017 and Mar. 4, 2018, etc.). In certain embodiments, the temporal information may be associated with an event associated with a particular point in time, a measure of time, an interval of time, or a combination thereof. As used herein, such a temporal event broadly refers to an occurrence, action or activity enacted by, or associated with, an entity at a particular point in time, for a measure of time, during an interval of time, or a combination thereof.

Examples of such temporal events include making a phone call, sending a text or an email, using a device, such as an endpoint device, accessing a system, and entering a physical facility. Other examples of temporal events include uploading, transferring, downloading, modifying, or deleting data, such as data stored in a datastore, or accessing a service. Yet other examples of temporal events include interactions between two or more users, interactions between a user and a device, interactions between a user and a network, and interactions between a user and a resource, whether physical or otherwise. Yet still other examples of temporal events include a change in name, address, physical location, occupation, position, role, marital status, gender, association, affiliation, or assignment.

As likewise used herein, temporal event information broadly refers to temporal information associated with a particular event. In various embodiments, the temporal event information may include certain types of content. In certain embodiments, such types of content may include text, unstructured data, structured data, graphical images, photographs, audio recordings, video recordings, and so forth. In certain embodiments, the entity information may include metadata. In various embodiments, the metadata may include temporal event attributes, which in turn may include certain entity identifier types or classifications, described in greater detail herein. In certain embodiments, the temporal event information may be used to resolve the identity of an entity at a particular point in time, for a measure of time, during an interval of time, or a combination thereof.

In certain embodiments, the security analytics system 118 may be implemented to use information associated with such temporal resolution of an entity's identity to assess the risk associated with a particular entity, for a measure of time, during an interval of time, or a combination thereof, and respond with an associated response. In certain embodiments, the security analytics system 118 may be implemented to respond to such assessments in order to reduce operational overhead and improve system efficiency while maintaining security integrity. In certain embodiments, the response to such assessments may be performed by a security administrator. Accordingly, certain embodiments of the invention may be directed towards assessing the risk associated with the affirmative resolution of the identity of an entity at a particular point in time, for a measure of time, during an interval of time, or a combination thereof, in combination with its associated contextual information. Consequently, the security analytics system 118 may be more oriented in various embodiments to risk mitigation than to security administration.

In certain embodiments, the security analytics system 118 may be implemented to resolve the identity of an entity by performing various entity resolution operations. As used herein, entity resolution broadly refers to resolving certain raw identifiers in input data to a particular entity. In certain embodiments, the entity resolution operations may include parsing, classifying and normalizing entity identifier information to generate entity identifier elements, which in turn are matched, or resolved, to a particular entity.

In certain embodiments, the performance of various entity resolution operations may result in new entity identifier elements being resolved to an existing, or previously-identified entity. In certain embodiments, the performance of various entity resolution operations may result in the creation of a previously-unknown or previously-unidentified entity. In these embodiments, the new entity identifier elements may be resolved to the newly-created entity. In certain embodiments, the entity identifier elements, and resolution data related to their association with a particular resolved entity 740, may be stored in a repository of entity identifier data 770.

In certain embodiments, the security analytics system 118 may be implemented to perform in-line entity resolution operations to resolve the identity of a particular entity. As used herein, in-line entity resolution broadly refers to resolving the identity of an entity prior to the performance of the next step of a particular process corresponding to an event associated with the entity. In certain embodiments, the security analytics system 118 may be implemented to include an event preprocessing system 702 and an in-line entity resolution system 120. In certain embodiments, the event preprocessing system 702 may be implemented to perform the event preprocessing operations 600 described in the descriptive text associated with FIG. 6. In certain embodiments, the event preprocessing system 702 may be implemented to generate extracted event features 626 from an event stream 602, as described in greater detail in the descriptive text associated with FIG. 6.

In certain embodiments, the in-line entity resolution system 120 may be implemented to include an entity identifier information parsing 704 module, an entity identifier element type classification 706 module, an entity identifier element normalization 708 module, an entity identifier element association 710 module, and an entity type reference engine 712, or some combination thereof. In certain embodiments, the entity identifier information parsing 704 module may be implemented to process extracted event features generated by the event preprocessing system 702 to generate entity identifier elements.

As an example, the event stream 602 may contain text stating, “John Smith was the VP of Sales for NewCo from May 9, 2016 through Jun. 15, 2017, at which time Bob Jones assumed the position, which he held until Nov. 20, 2017.” In this example, the resulting extracted event features may include “John Smith,” “Bob Jones,” “VP of Sales,” “NewCo,” “May 9, 2016,” “Jun. 15, 2017,” and “Nov. 20, 2017.” To continue the example, the resulting entity identifier elements generated by the entity identifier information parsing 704 module may include “John Smith,” “Bob Jones,” “VP of Sales,” and “NewCo.” To further continue the example, the extracted event features of “May 9, 2016,” “Jun. 15, 2017,” and “Nov. 20, 2017” may be used as temporal identity resolution factors, described in greater detail herein, to assist in the performance of in-line entity resolution operations.

As another example, the event stream 602 may include a data record associated with a package delivery, which in turn may include a delimited string of data such as, “Rob Adams, NewCo, 30.648748, -97.687856, John Smith, 02.17.2018, 2:03.” In this example, the resulting extracted event features may include “Rob Adams,” “NewCo,” “30.648748,” “-97.687856,” “John Smith,” “02.17.2017,” and “2:03.” To continue the example, the resulting entity identifier elements generated by the entity identifier information parsing 704 module may include “Rob Adams,” “NewCo,” and “John Smith.” To further continue the example, the extracted event features of “30.648748” and “-97.687856” may be used as location data and the extracted event features “02.17.2017” and “2:03” may be used as temporal identity resolution factors, all of which may be used to assist in the performance of in-line entity resolution operations.

As yet another example, the event stream 602 may include an email address, such as “John Smith john.smith@newco.com”. In this example, the resulting extracted event features may include “John Smith,” “john.smith,” and “newco.com,” all of which may be used as entity identifier elements. As yet still another example, the event stream 602 may include a timestamped log of a file downloaded from a particular datastore, such as “jsmith, abc123!, salesleads.xls, 2017.04.04, 16:33:24:45.” In this example, the resulting extracted event features may include “jsmith,” and “abc123!,” “salesleads.xls,” “2017.04.04,” and “16:33:24:45.” To continue the example, the extracted event features of “jsmith,” and “abc123!” may be used as entity identifier elements. Likewise, the extracted event feature of “salesleads.xls” may be used as contextual information and the extracted event features “2017.04.04” and “16:33:24:45” may be used as temporal identity resolution factors, all of which may be used to assist in the performance of in-line entity resolution operations.

In certain embodiments, the entity identifier element type classification module 706 may be implemented to use the entity type reference engine 712 to assign an entity identifier element type to each entity identifier element generated by the entity identifier information parsing module 704. As used herein, an entity identifier element type broadly refers to a representation of a particular attribute associated with an entity identifier element. In certain embodiments, the entity type reference engine 712 may be implemented to use a repository of entity identifier classification rules 772 to assign an entity identifier element type to each entity identifier element.

Using the prior examples to illustrate the use of the entity identifier element type classification 706 module, the entity identifier elements “John Smith,” “Bob Jones,” and “Rob Adams” may each be recognized as a person's name. Accordingly, they may have a “name” entity identifier element type assigned to them. Likewise, the entity identifier elements “john.smith” and “jsmith” may be respectively recognized as an email address name and a user ID. Accordingly, they may respectively be assigned “email name” and “user name” entity identifier element types.

To continue using the prior examples, the entity identifier elements “VP of Sales” and “NewCo” may be respectively recognized as a person's title and the name of a company, while “newco.com” may be recognized as a domain name. Accordingly, they may respectively be assigned “title,” “company,” and “domain” entity identifier element types. Likewise, the temporal identity resolution factors of “May 9, 2016,” “Jun. 15, 2017,” “Nov. 20, 2017,” “02.17.2018,” “2017.04.04,” may all be recognized as dates in different formats, while “2:03” and “16:33:24:45” may both be recognized as timestamps. Accordingly, they may respectively be assigned “date” and “time” entity identifier element types.

To further continue using the prior examples, the extracted event features of “30.648748” and “-97.687856” may be recognized as Global Positioning System (GPS) coordinates. Accordingly, they may be assigned an entity identifier element type of “GPS.” Likewise, the entity identifier elements of “abc123!” and “salesleads.xls” may respectively be recognized as a password and a file name. Accordingly they may respectively be assigned entity identifier element types of “password” and “file name.”

In certain embodiments, the identity resolution system 118 may be implemented to include an entity identifier element normalization 708 module. In certain embodiments, the entity identifier element normalization 708 module may be implemented to normalize entity identifier elements classified by the entity identifier element type classification 706 module. In certain embodiments, the entity identifier element normalization 708 module may be implemented to use rules stored in a repository of entity identifier normalization rules 772 to normalize an entity identifier element.

In certain embodiments, the entity identifier element normalization 708 module may be implemented to generate type-dependent normalized entity identifier elements. As an example, an entity identifier element may be classified as an email entity identifier type. However, the entity identifier element may be further classified to be a Simple Mail Transport Protocol (SMTP) or Microsoft® Exchange® email address. Accordingly, in certain embodiments, the classified entity identifier element may be respectively processed to generate a type-dependent normalized entity identifier element according to whether it is an SMTP or Exchange® email address. In certain embodiments, the normalization operations performed by the entity identifier element normalization 708 module may result in an inferred relationship between two or more entity identifier elements, as described in greater detail herein.

Using the prior examples to illustrate the use of the entity identifier element normalization 708 module, the temporal identity resolution factors of “May 9, 2016,” “Jun. 15, 2017,” “Nov. 20, 2017,” “02.17.2018,” and “2017.04.04” may all be assigned an entity identifier type of “date,” yet they do not share a consistent format. Accordingly, they may respectively be normalized by the entity identifier element normalization 708 module into a common format, such as “2016.05.09,” “2017.06.15,” “2017.11.20,” “02.17.2018,” and “2017.04.04.” Likewise, the temporal identity resolution factors of “2:03” and “16:33:24:45” may both be assigned an entity identifier type of “time,” yet they do not share the same format. Accordingly, they may respectively be normalized by the entity identifier element normalization 708 module into a common format, such as “02:03:00:00” and “16:33:24:45.”

In continuing to use the prior examples to illustrate the use of the entity identifier element normalization 708 module, the event stream 602 may have contained an email address of “John Smith <john.smith@newco.com>”. In the prior example, the resulting entity identifier elements included “John Smith,” “john.smith,” and “newco.com.” Likewise, the entity identifier elements of “john.smith,” and “newco.com” were respectively assigned entity identifier types of “email name” and “domain.” Accordingly, the original email address of “John Smith <john.smith@newco.com>” may be normalized into a uniform format, such as “john.smith@newco.com.”

In certain embodiments, the entity identifier element normalization 708 module may be implemented to normalize a variety of entity identifier information, such as user authentication factors, user identity factors, location data, information associated with various endpoint and edge devices, internal and external network addresses, resource entities, or a combination thereof. Skilled practitioners of the art will recognize that many such embodiments are possible. Accordingly, the foregoing is not intended to limit the spirit, scope or intent of the invention.

In certain embodiments, the entity identifier element association 710 module may be implemented to associate related entity identifier elements that have respectively been classified and normalized by the entity identifier element type classification 706 module and the entity identifier element normalization 708 module. In various embodiments, the entity identifier element association 710 module may be implemented to associate certain temporal information with a classified or normalized entity identifier element.

In certain embodiments, the temporal information may include the time at which related entity identifier elements that have respectively been classified and normalized by the entity identifier element type classification 706 module and the entity identifier element normalization 708 module. In certain embodiments, the temporal information may include the time at which a normalized entity identifier element has been matched, or resolved, to a particular entity. In certain embodiments, the association operations performed by the entity identifier element association 710 module may result in the classified and normalized entity identifier elements to be cross-referenced to one another or otherwise indexed.

In certain embodiments, the association operations performed by the entity identifier element association 710 module may result in the cross-referencing, or indexing, of classified and normalized entity identifier elements that were not originally related to one another. To continue using the prior examples to illustrate such cross-referencing, the entity identifier elements “John Smith,” “VP of Sales,” “NewCo,” “2016.05.09,” “2017.06.15,” “john.smith,” “newco.com” “jsmith,” and “abc123!” may have been parsed, classified and normalized from different event streams 602. However, they are all related to one another. Accordingly, they may be cross-referenced, or otherwise indexed, to create a unified data record, such as “John Smith, VP of Sales, Newco, john.smith@newco.com, jsmith, abc123!, 2016.05.09, 2017.06.15.” In certain embodiments, the entity identifier element association 710 module may be implemented to store such cross-referenced, or otherwise indexed, entity identifier data elements in a repository of entity identifier data 770.

In certain embodiments, the event stream 602 may be received in real-time. In certain embodiments the in-line resolution of the identity of an entity may be performed in real-time. In certain embodiments, the in-line entity resolution system 120 may be implemented to use identity reference data stored in the repository of entity identifier data 770 to resolve the identity of an entity. In certain embodiments, the security analytics system 118 may be implemented to process various entity queries 720 by performing entity querying operations.

As used herein, entity querying operations broadly refer to operations associated with parsing, classifying and normalizing entity identifiers to generate entity identifier elements, which are in turn processed to identify, or resolve, a corresponding entity. In certain embodiments, the identification, or resolution, of the entity is performed by using the entity identifier elements to query a repository of entity identifier data 770. In certain embodiments, performance of the entity querying operations may result in the identification of additional entity identifier elements associated with the identified, or resolved, entity. In certain embodiments, such additional entity identifier elements may be returned as a result of performing the entity querying operations.

In certain embodiments, the entity querying operations may be performed in response to receiving an entity query 720 from a risk service 422, described in greater detail in the descriptive text associated with FIG. 4. In certain embodiments, the entity querying operations may be performed in response to receiving an entity query from a security analytics system or service, likewise described in greater detail herein. In certain embodiments, the entity querying operations may be performed in response to receiving an entity query from a querying system. In these embodiments, the querying system selected to submit an entity query 720 for entity identifier data 770 to the security analytics system 118 is a matter of design choice.

In certain embodiments, the entity identifier elements returned as a result of the entity querying operations may be used in combination with other data to perform various security analysis operations. Skilled practitioners of the art will appreciate that such security analysis operations will likely be more useful and accurate when aggregated by a particular entity instead of by various entity identifier elements. Those of skill in the art will likewise recognize that many such embodiments are possible. Accordingly, the foregoing is not intended to limit the spirit, scope or intent of the invention.

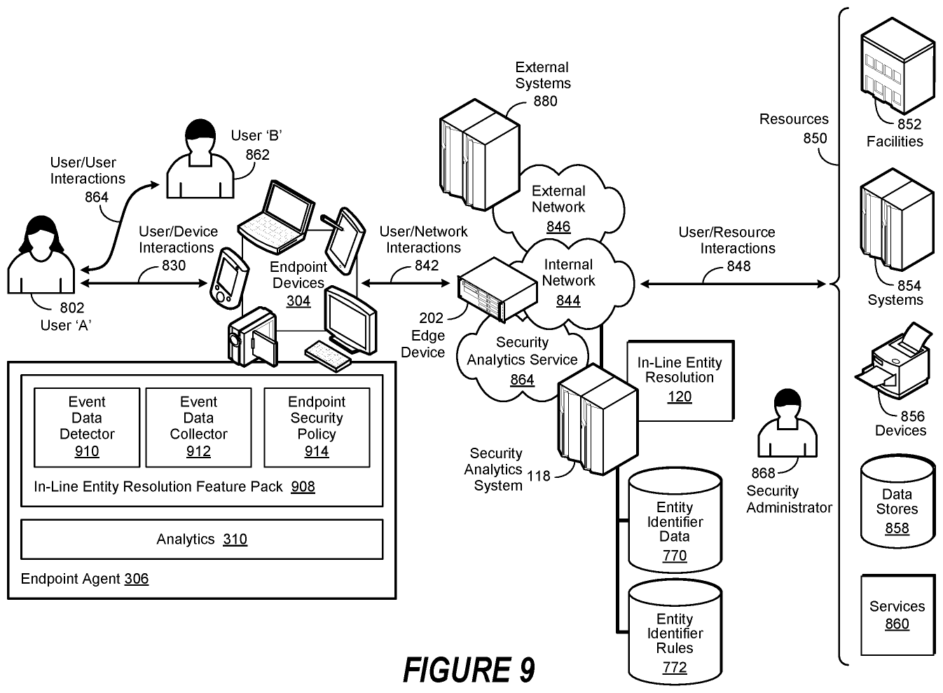

FIGS. 8a and 8b are a simplified block diagram of the operation of a security analytics system implemented in accordance with an embodiment of the invention. In certain embodiments, analyses performed by the security analytics system 118 may be used to identify anomalous, abnormal, unexpected or malicious behavior associated with a user. In certain embodiments, the anomalous, abnormal, unexpected or malicious behavior may be identified at a particular point in time, during the occurrence of an event, the enactment of a user behavior, or a combination thereof.

In certain embodiments, information associated with such user behavior may be stored in a user profile. As used herein, a user profile broadly refers to a collection of information that uniquely describes a user's identity and their associated behavior, whether the behavior occurs within a physical realm or cyberspace. In certain embodiments, the user profile may be stored in a repository of user profiles 870. In certain embodiments, as described in greater detail herein, the user profile may include user profile attributes 812, user behavior factors 814, user mindset factors 828, or a combination thereof.

In certain embodiments, the security analytics system 118 may be implemented with an in-line entity resolution system 120, described in greater detail herein. In certain embodiments, the in-line entity resolution system 120 may be implemented to perform various in-line entity resolution operations, likewise described in greater detail herein. In certain embodiments, various user profile attributes 812, user behavior factors 814, user mindset factors 828, or a combination thereof, may be used by the security analytics system 118 to perform the in-line entity resolution operations.

As used herein, a user profile attribute 812 broadly refers to data or metadata that can be used, individually or in combination with other user profile attributes 812, to uniquely ascertain the identity of an entity. In certain embodiments, the user profile attributes 812 may include certain personal information. In certain embodiments, the personal information may include non-sensitive personal information associated with a user, such as their name, title, position, role, and responsibilities. In certain embodiments, the personal information may likewise include technical skill level information, peer information, expense account information, paid time off (PTO) information, data analysis information, insider information, misconfiguration information, third party information, or a combination thereof

In certain embodiments, the personal information may contain sensitive personal information associated with a user. As used herein, sensitive personal information (SPI), also commonly referred to as personally identifiable information (PII), broadly refers to any information usable to ascertain the identity of a user, either by itself, or in combination with other information, such as contextual information described in greater detail herein. Examples of SPI may include the full or legal name of a user, initials or nicknames, place and date of birth, home and business addresses, personal and business telephone numbers, their gender, and other genetic information.

Additional examples of SPI may include government-issued identifiers, such as a Social Security Number (SSN) or a passport number, vehicle registration plate and serial numbers, and driver's license numbers. Other examples of SPI may include certain email addresses and social media identifiers, credit and debit card numbers, and other digital identity information. Yet other examples of SPI may include employer-issued identifiers, financial transaction information, credit scores, electronic medical records (EMRs), insurance claim information, personal correspondence, and so forth. Further examples of SPI may include user authentication factors 804, such as biometrics 806, tokens 808, user identifiers and passwords 810, and personal identification numbers (PINs).

In certain embodiments, the user authentication factors 804 may be used to authenticate the identity of a user, such as user ‘A’ 802 or ‘B’ 862. In certain embodiments, the user authentication factors 806 may be used to ensure that a particular user, such as user ‘A’ 802 or ‘B’ 862, is associated with their corresponding user profile, rather than a user profile associated with another user. In certain embodiments, the user authentication factors 804 may include a user's biometrics 806, an associated security token 808, (e.g., a dongle containing cryptographic keys), or a user identifier/password (ID/PW) 810.

In certain embodiments, the user authentication factors 804 may be used in combination to perform multi-factor authentication of a user, such as user ‘A’ 802 or ‘B’ 862. As used herein, multi-factor authentication broadly refers to approaches requiring two or more authentication factors. In general, multi-factor authentication includes three classes of user authentication factors 804. The first is something the user knows, such as a user ID/PW 810. The second is something the user possesses, such as a security token 808. The third is something that is inherent to the user, such as a biometric 806.

In certain embodiments, multi-factor authentication may be extended to include a fourth class of factors, which includes one or more user behavior factors 814, or portions thereof. In these embodiments, the fourth class of factors may include user behavior the user has previously enacted, is currently enacting, or is expected to enact at some point in the future. In certain embodiments, the enactment of a user behavior may be associated with a particular event. In certain embodiments, multi-factor authentication may be performed on recurring basis. In various embodiments, the multi-factor authentication may be performed at certain time intervals during the enactment of a particular user behavior. In certain embodiments, the time interval may be uniform. In certain embodiments, the time interval may vary or be random.

In certain embodiments, the multi-factor authentication may be performed according to the occurrence of an event or the enactment of a particular user behavior, such as accessing a resource 850. In various embodiments, certain combinations of the multi-factor authentication described herein may be used according to the enactment of a particular user behavior. From the foregoing, those of skill in the art will recognize that the addition of such a fourth class of factors not only strengthens current multi-factor authentication approaches, but further, allows the factors to be more uniquely associated with a given user and their corresponding user profile.

Those of skill in the art will be aware that it is not uncommon for hackers, criminals and other actors to use various SPI to impersonate a user in order to gain unauthorized access to various systems, data, or facilities. It is likewise not uncommon for such individuals to masquerade as a user in order to collect their associated SPI for the purpose of identity theft. One known approach to gathering a user's SPI is to illicitly capture a data stream, such as a flow of network packets that include SPI sent by a user to another machine, such as an external system 880. Defenses against such approaches include encrypting the data stream prior to its communication across a network, such as the internal 844 or external 846 networks shown in FIG. 8b.

However, other approaches, such as the use of a key logger, may surreptitiously capture the user's keystrokes or user gestures 826, described in greater detail herein, and communicate the resulting data stream in their native form to a hacker or other infiltrator. Another issue is the possibility that a normally-trusted insider, such as a security administrator 868, may have access to a decrypted data stream as part of their day-to-day responsibilities. As an example, a security administrator 868 may be using a security analytics 400 system to perform threat analysis related to a particular user. In the process, they may be exposed to various SPI associated with the user, such as certain user IDs and passwords 810. It will be appreciated that such exposure creates the opportunity for a security breach, whether intended or not. Another approach is to impersonate a legitimate website. In such approaches, the user may navigate to the site and innocently enter their ID/password 810, only to have them captured for later use in illegal activities.

As used herein, a user behavior factor 814 broadly refers to information associated with a user's behavior, whether the behavior occurs within a physical realm or cyberspace. In certain embodiments, user behavior factors 814 may include the user's access rights 816, the user's interactions 818, and the date/time/frequency 820 of when the interactions 818 are enacted. In certain embodiments, the user interactions 818 may include user/device 830, user/network 842, user/resource 848, user/user 864 interactions, or some combination thereof. In certain embodiments, the user/device 830 interactions may include an interaction between a user, such as user ‘A’ 602 or ‘B’ 662, and an endpoint device 304. In certain embodiments, the user behavior factors 814 may likewise include the user's location 824, and the gestures 826 used to enact the interactions 818.

In certain embodiments, the user gestures 826 may include key strokes on a keypad, a cursor movement, a mouse movement or click, a finger swipe, tap, or other hand gesture, an eye movement, or some combination thereof. In certain embodiments, the user gestures 826 may likewise include the cadence of the user's keystrokes, the motion, force and duration of a hand or finger gesture, the rapidity and direction of various eye movements, or some combination thereof. In certain embodiments, the user gestures 826 may include various audio or verbal commands performed by the user.

In various embodiments, certain date/time/frequency 820 user behavior factors 814 may be implemented as ontological or societal time, or a combination thereof. As used herein, ontological time broadly refers to how one instant in time relates to another in a chronological sense. As an example, a first user behavior enacted at 12:00 noon on May 17, 2017 has occurred prior to a second user behavior enacted at 6:39 PM on May 18, 2018. Skilled practitioners of the art will recognize one value of ontological time is to determine the order in which various user behaviors have been enacted.

As likewise used herein, societal time broadly refers to the correlation of certain user profile attributes 812, user behavior factors 814, user mindset factors 828, or a combination thereof, to one or more instants in time. As an example, user ‘A’ 802 may access a system 854 to download a customer list at 3:47 PM on Nov. 3, 2017. Analysis of their user behavior profile indicates that it is not unusual for user ‘A’ 802 to download the customer list on a weekly basis. However, examination of their user behavior profile also indicates that user ‘A’ 802 forwarded the downloaded customer list in an email message to user ‘B’ 862 at 3:49 PM that same day. Furthermore, there is no record in their user behavior profile that user ‘A’ 802 has ever communicated with user ‘B’ 862 in the past. Moreover, it may be determined that user ‘B’ 862 is employed by a competitor. Accordingly, the correlation of user ‘A’ 802 downloading the customer list at one point in time, and then forwarding the customer list to user ‘B’ 862 at a second point in time shortly thereafter, is an example of societal time.

In a variation of the prior example, user ‘A’ 802 may download the customer list at 3:47 PM on Nov. 3, 2017. However, instead of immediately forwarding the customer list to user ‘B’ 862, user ‘A’ 802 leaves for a two week vacation. Upon their return, they forward the previously-downloaded customer list to user ‘B’ 862 at 9:14 AM on Nov. 20, 2017. From an ontological time perspective, it has been two weeks since user ‘A’ 802 accessed a system 854 to download the customer list. However, from a societal time perspective, they have still forwarded the customer list to user ‘B’ 862, despite two weeks having elapsed since the customer list was originally downloaded.

Accordingly, the correlation of user ‘A’ 802 downloading the customer list at one point in time, and then forwarding the customer list to user ‘B’ 862 at a much later point in time, is another example of societal time. More particularly, it may be inferred that the intent of user ‘A’ 802 did not changed during the two weeks they were on vacation. Furthermore, user ‘A’ 802 may have attempted to mask an intended malicious act by letting some period of time elapse between the time they originally downloaded the customer list and when they eventually forwarded it to user ‘B’ 862. From the foregoing, those of skill in the art will recognize that the use of societal time may be advantageous in determining whether a particular user behavior is acceptable, anomalous, abnormal, unexpected or malicious.

As used herein, mindset factors 828 broadly refer to information used to determine the mental state of a user at a particular point in time, during the occurrence of an event or an enactment of a user behavior, or combination thereof. As used herein, mental state broadly refers to a hypothetical state corresponding to the way a user may be thinking or feeling. In certain embodiments, the user mindset factors 828 may include a personality type. Examples of known approaches for determining a personality type 624 include Jungian types, Myers-Briggs type indicators, Keirsy Temperament Sorter, Socionics, Enneagram of Personality, and Eyseneck's three-factor model.

In certain embodiments, the mindset factors 828 may include various behavioral biometrics. As likewise used herein, a behavioral biometric broadly refers to a physiological indication of a user's mental state. Examples of behavioral biometrics may include a user's blood pressure, heartrate, respiratory rate, eye movements and iris dilation, facial expressions, body language, tone and pitch of voice, speech patterns, and so forth.

Certain embodiments of the invention reflect an appreciation that certain user behavior factors 814, such as user gestures 826, may provide additional information related to determining a user's mental state. As an example, a user entering text at a quick pace with a rhythmic cadence may indicate intense focus. Likewise a user intermittently entering text with forceful keystrokes may indicate the user is in an agitated state. As another example, the user may intermittently enter text somewhat languorously, which may indicate being in a thoughtful or reflective state of mind. As yet another example, the user may enter text with a light touch with an uneven cadence, which may indicate the user is hesitant or unsure of what is being entered.

Certain embodiments of the invention likewise reflect an appreciation that while the user gestures 826 may indicate the mental state of a user, they may not provide the reason for the user to be in a particular mental state. Likewise, certain embodiments of the invention include an appreciation that certain user gestures 826 and behavioral biometrics are reflective of a user's personality type. As an example, aggressive, forceful keystrokes combined with an increased heart rate may indicate normal behavior for a particular user when composing end-of-month performance reviews. In various embodiments, certain user behavior factors 814, such as user gestures 826, may be correlated with certain contextual information.

As used herein, contextual information broadly refers to any information, directly or indirectly, individually or in combination, related to a particular user behavior. In certain embodiments, user behavior may include a user's physical behavior, cyber behavior, or a combination thereof. As likewise used herein, a user's physical behavior broadly refers to any user behavior occurring within a physical realm, such as speaking, gesturing, facial patterns or expressions, walking, and so forth. More particularly, such physical behavior may include any action enacted by a user that can be objectively observed, or indirectly inferred, within a physical realm. In certain embodiments, the objective observation, or indirect inference, of the physical behavior may be performed electronically.

As an example, a user may attempt to use an electronic access card to enter a secured building at a certain time. In this example, the use of the access card to enter the building is the action and the reading of the access card makes the user's physical behavior electronically-observable. As another example, a first user may physically transfer a document to a second user, which is captured by a video surveillance system. In this example, the physical transferal of the document from the first user to the second user is the action. Likewise, the video record of the transferal makes the first and second user's physical behavior electronically-observable. As used herein, electronically-observable user behavior broadly refers to any behavior exhibited or enacted by a user that can be observed through the use of an electronic device (e.g., an electronic sensor), a computing device or system (e.g., an endpoint device 304), computer instructions (e.g., a software application), or a combination thereof.

Cyber behavior, as used herein, broadly refers to any behavior occurring in cyberspace, whether enacted by an individual user, a group of users, or a system acting at the behest of an individual user, a group of users, or an entity. More particularly, cyber behavior may include physical, social, or mental actions that can be objectively observed, or indirectly inferred, within cyberspace. As an example, a user may use an endpoint device 304 to access and browse a particular website on the Internet. In this example, the individual actions performed by the user to access and browse the website constitute a cyber behavior. As another example, a user may use an endpoint device 304 to download a data file from a particular system at a particular point in time. In this example, the individual actions performed by the user to download the data file, and associated temporal information, such as a time-stamp associated with the download, constitute a cyber behavior. In these examples, the actions are enacted within cyberspace, in combination with associated temporal information, which makes them electronically-observable.

As likewise used herein, cyberspace broadly refers to a network environment, such as an internal 844 or external 846 network, capable of supporting communication between two or more entities. In certain embodiments, the entity may be a user, an endpoint device 304, or various resources, described in greater detail herein. In certain embodiments, the entities may include various endpoint devices 304 or resources 850 operating at the behest of an entity, such as a user. In certain embodiments, the communication between the entities may include audio, image, video, text, or binary data.

In certain embodiments, the contextual information may include a user's authentication factors 804. In certain embodiments, contextual information may likewise include various user identity resolution factors, such as personal information associated with the user, the date/time/frequency 820 of various user behavior, the user's location 824, the user's role or position in an organization, their associated access rights 816, and certain user gestures 826 employed by the user in the enactment of a user behavior. Other contextual information may likewise include various user interactions, whether the interactions are with an endpoint device 304, a network 140, a resource 850, or another user. In certain embodiments, user behaviors, and their related contextual information, may be collected at particular points of observation, and at particular points in time, described in greater detail herein.

In certain embodiments, a user profile may be processed with associated contextual information to generate correlated contextual information. In certain embodiments, the correlated contextual information, along with a user's user profile, may be used to perform certain user behavior analysis. In certain embodiments, the user behavior analysis may be performed by the security analytics system 118. In certain embodiments, the security analytics system 118 may be implemented to process a user profile and certain correlated contextual information associated with a user to determine their mental state at a particular point in time. In certain embodiments, the mental state of a user at a particular point in time may be used in combination with various user profile attributes 812 and user behavior factors 814, in the context of an associated user state, to infer a user's intent.

In certain embodiments, a user profile may be used with a first set of contextual information to determine the user's mental state at a first point in time and a second set of contextual information to determine their mental state at a second point in time. In certain embodiments, the user's mental state at a first point in time may correspond to the occurrence of a first user event and the user's mental state at a second point in time may correspond to the occurrence of a second user event. Certain embodiments of the invention reflect an appreciation that such a first and second set of contextual information may be decidedly different, which may provide context for the user's mental state at different times and during the occurrence of different user events. Likewise, the first and second set of contextual information may be substantively the same, which may provide an indication that while the user's mental state may be different at two points in time, or during the occurrence of two different user events, the cause of their mental state may not be related to the contextual information that was collected at the two points in time.

It will be appreciated that over time, the user behavior of a particular user, such as user ‘A’ 802, will be uniquely different and distinct from another user, such as user ‘B’ 862. Accordingly, user profile ‘1’ will uniquely reflect the user behavior of user ‘1’, just as user profile ‘n’ will uniquely reflect the user behavior of user ‘n’. As an example, user ‘A’ 802 may have a user profile attribute 812 of sales administrator. Upon arriving at their office in the morning, the user consistently checks their email, item by item, responding to each in turn, followed by processing expense reports for field sales personnel. Then, after lunch, the user may access and review sales forecasts on an internal system 854. Furthermore, the user may exhibit sporadic keyboard entry interspersed with extensive mouse activity, or user gestures 826, when perusing the sales forecasts.

Moreover, personality type information associated with user ‘A’ 802 may indicate the user consistently exhibits a positive, outgoing attitude. In this example, the sequence of the activities enacted by user ‘A’ 802 throughout the day, and their frequency, correspond to their expected date/time/frequency 820 user behavior factors 814. Likewise, the keyboard cadence and other user gestures 826 are examples of granular user behavior factors 814, while the personality type information is an example of an abstract user behavior factor 814.

As another example, user ‘B’ 862 may have a user profile attribute 812 of financial controller. Upon arriving at their office in the morning, the user usually scans their email messages, responding only to those that are urgent. Then they check the daily budget status of each department to see whether they are conforming to their respective guidelines. After lunch, the user may follow up on emails that are less urgent, followed by updating the organization's financials, likewise on an internal system 854. Additionally, user ‘B’ 862 may exhibit deliberate keyboard entry interspersed with iterative mouse activity, or user gestures 826, when updating financial information. Moreover, personality type information associated with user ‘B’ 862 may indicate they consistently exhibit a reserved, introspective and contemplative attitude. As in the prior example, the sequence of the activities enacted by user ‘B’ 862 throughout the day, and their frequency, correspond to their expected date/time/frequency 820 user behavior factors 814. Likewise, as before, the keyboard cadence and other user gestures 826 are examples of granular user behavior factors 814, while the personality type information is an example of an abstract user behavior factor 814.

It will likewise be appreciated that the user behavior of a particular user may evolve over time. As an example, certain user behavior exhibited by a user during the first month of assuming a new position within an organization may be quite different than the user behavior exhibited after being in the position for six months. To continue the example, the user may be somewhat tentative when learning to access and interact with unfamiliar resources 850 in the first month in the position, but by the sixth month, such access and interaction is commonplace and routine.

In certain embodiments, a user behavior factor 814 associated with a particular user, such as user ‘A’ 802 or ‘B’ 862, may be used by the security analytics system 118 to compare the user's current user behavior to past user behavior. If the user's current user behavior matches their past user behavior, then the security analytics system 118 may determine that the user's user behavior is acceptable. If not, then the user profile management system 118 may determine that the user's user behavior is anomalous, abnormal, unexpected or malicious.

However, as described in greater detail herein, a change in a particular user's user behavior over time may not be anomalous, abnormal, unexpected, or malicious. Instead, it may be acceptable behavior that simply evolves over time as a natural result of day-to-day user/device 830, user/network 842, user/resource 848, or user/user 864 interactions. In certain embodiments, the security analytics system 118 may be implemented to determine whether such changes in a user's user behavior over time are acceptable, anomalous, abnormal, unexpected or malicious. In certain embodiments, a user behavior profile may be implemented in combination with the security analytics system 118 to make this temporal determination.

It will be appreciated that anomalous, abnormal, unexpected or malicious user behavior may include inadvertent or compromised user behavior. For example, the user may have innocently miss-entered a request for data that is proprietary to an organization. As another example, the user may be attempting to access confidential information as a result of being compromised. As yet another example, a user may attempt to access certain proprietary data from their home, over a weekend, and late at night. In this example, the user may be working from home on a project with an impending deadline. Accordingly, the attempt to access the proprietary data is legitimate, yet still anomalous, abnormal or unexpected as the attempt did not occur during the week, from the user's place of employment, during normal work hours. However, the user behavior may manifest in context with consistent remote access patterns and provide sufficient evidence to determine the nature of the activity.

Likewise, the security analytics system 118 may determine that the user's user behavior to be malicious. As yet another example, an impostor may be attempting to pose as a legitimate user in an attempt to exploit one or more resources 850. In this example, the attempt to exploit one or more resources 850 is malicious user behavior. As yet still another example, a legitimate user may be attempting to increase their level of access to one or more resources 850. In this example, the user's attempt to increase their level of access may indicate malicious user behavior.

To further extend these examples, such resources 850 may include various facilities 852, systems 854, devices 856 (e.g., a printer, a FAX machine, a copier, etc.), data stores 858, or services 860. In certain embodiments, the security analytics system 118 may be implemented to block a user if it is determined their user behavior is anomalous, abnormal, unexpected or malicious. In certain embodiments, the security analytics system 118 may be implemented to modify a request submitted by a user if it is determined the request is anomalous, abnormal, unexpected or malicious. In certain embodiments, the security analytics system 118 may be implemented to modify an outcome. For example, the security analytics system 118 may encrypt a file when a copy operation or request is detected.

In certain embodiments, the user profile may be implemented as a cyberprofile. A cyberprofile, as used herein, broadly refers to a collection of information that uniquely describes an entity and their associated behavior within cyberspace. In certain embodiments, the security analytics system 118 may be implemented to use information associated with certain user behavior elements to define and manage a user profile. A user behavior element, as used herein, broadly refers to a discrete element of a user's behavior during the performance of a particular operation, or the occurrence of a particular event, in a physical realm, cyberspace, or a combination thereof In certain embodiments, such user behavior elements may be associated with a user/device 830, a user/network 842, a user/resource 848, a user/user 864 interaction, or combination thereof.

As an example, user ‘A’ 802 may use an endpoint device 304 to browse a particular web page on a news site on the Internet. In this example, the individual actions performed by user ‘A’ 802 to access the web page are user behavior elements that constitute a user behavior. As another example, user ‘A’ 802 may use an endpoint device 304 to download a data file from a particular system 854. In this example, the individual actions performed by user ‘A’ 802 to download the data file, including the use of one or more user authentication factors 804 for user authentication, are user behavior elements that constitute a user behavior. In certain embodiments, the user/device 830 interactions may include an interaction between a user, such as user ‘A’ 802 or ‘B’ 862, and an endpoint device 304.

In certain embodiments, the user/device 830 interaction may include interaction with an endpoint device 304 that is not connected to a network at the time the interaction occurs. As an example, user ‘A’ 802 or ‘B’ 862 may interact with an endpoint device 304 that is offline, using applications 832, accessing data 834, or a combination thereof, it may contain. Those user/device 830 interactions, or their result, may be stored on the endpoint device 304 and then be accessed or retrieved at a later time once the endpoint device 304 is connected to the internal 844 or external 846 networks.

In certain embodiments, the endpoint device 304 may be used to communicate data through the use of an internal network 844, an external network 846, or a combination thereof. In certain embodiments, the internal 844 and the external 846 networks may include a public network, such as the Internet, a physical private network, a virtual private network (VPN), or any combination thereof. In certain embodiments, the internal 844 and external 846 networks may likewise include a wireless network, including a personal area network (PAN), based on technologies such as Bluetooth. In various embodiments, the wireless network may include a wireless local area network (WLAN), based on variations of the IEEE 802.11 specification, commonly referred to as WiFi. In certain embodiments, the wireless network may include a wireless wide area network (WWAN) based on an industry standard including various 3G, 4G and 5G technologies.

In certain embodiments, the user/resource 848 interactions may include interactions with various resources 850. In certain embodiments, the resources 850 may include various facilities 852 and systems 854, either of which may be physical or virtual, as well as data stores 856 and services 858. In certain embodiments, the user/user 864 interactions may include interactions between two or more users, such as user ‘A’ 802 and ‘B’ 862. In certain embodiments, the user/user interactions 864 may be physical, such as a face-to-face meeting, via a user/device 830 interaction, a user/network 842 interaction, a user/resource 848 interaction, or some combination thereof.

In certain embodiments, the user/user 864 interaction may include a face-to-face verbal exchange between two users. In certain embodiments, the user/user 864 interaction may include a written exchange, such as text written on a sheet of paper, between two users. In certain embodiments, the user/user 864 interaction may include a face-to-face exchange of gestures, such as a sign language exchange, between two users. In certain embodiments, temporal event information associated with various interactions 830, 842, 848, 860 may be collected and used to define and manage a user profile.

In certain embodiments, the security analytics system 118 may be implemented to observe user behavior at one or more points of observation within a physical domain or cyberspace environment. In certain embodiments, the points of observation may occur during various user interactions, such as user/device 830, user/network 842, user/resource 848, and user/user 864 interactions described in greater detail herein. As an example, a user/user 864 interaction may include an interaction between user ‘A’ 802 and ‘B’ 862.

In certain embodiments, the point of observation may include cyber behavior of various kinds within an internal 844 network. As an example, the cyber behavior within an internal 844 network may include a user accessing a particular internal system 854 or data store 856. In certain embodiments, the point of observation may include cyber behavior of various kinds within an external 846 network. As an example, the cyber behavior within an external 846 network may include a user's social media activities or participation in certain user forums. Those of skill in the art will recognize that many such examples of user/device 830, user/network 842, user/resource 848, and user/user 864 interactions are possible. Accordingly, the foregoing is not intended to limit the spirit, scope or intent of the invention.

In certain embodiments, the security analytics system 118 may be implemented to process certain contextual information to ascertain the identity of an entity at a particular point in time. In certain embodiments, the contextual information may include location data 836. In certain embodiments, the endpoint device 304 may be configured to receive such location data 836, which is used as a data source for determining the user's location 824.

In certain embodiments, the location data 836 may include Global Positioning System (GPS) data provided by a GPS satellite 838. In certain embodiments, the location data 836 may include location data 836 provided by a wireless network, such as from a cellular network tower 840. In certain embodiments (not shown), the location data 836 may include various Internet Protocol (IP) or other network address information assigned to the endpoint 304 or edge 202 device. In certain embodiments (also not shown), the location data 836 may include recognizable structures or physical addresses within a digital image or video recording.

In certain embodiments, the endpoint devices 304 may include an input device (not shown), such as a keypad, magnetic card reader, token interface, biometric sensor, digital camera, video surveillance camera, and so forth. In certain embodiments, such endpoint devices 304 may be directly, or indirectly, connected to a particular facility 852 or system 854. As an example, the endpoint device 304 may be directly connected to an ingress/egress system, such as an electronic lock on a door or an access gate of a parking garage. As another example, the endpoint device 304 may be indirectly connected to a physical security mechanism through a dedicated security network.

In certain embodiments, the security analytics system 118 may be implemented as a stand-alone system. In certain embodiments, the security analytics system 118 may be implemented as a distributed system. In certain embodiment, the security analytics system 118 may be implemented as a virtual system, such as an instantiation of one or more virtual machines (VMs). In certain embodiments, the security analytics system 118 may be implemented to use various event data stored in a repository of persistent event data 670 to perform certain probability distribution analyses, described in greater detail herein.

In certain embodiments, the security analytics system 118 may be implemented as a security analytics service 864. In certain embodiments, the security analytics service 864 may be implemented in a cloud environment familiar to those of skill in the art. Those of skill in the art will recognize that many such embodiments are possible. Accordingly, the foregoing is not intended to limit the spirit, scope or intent of the invention.

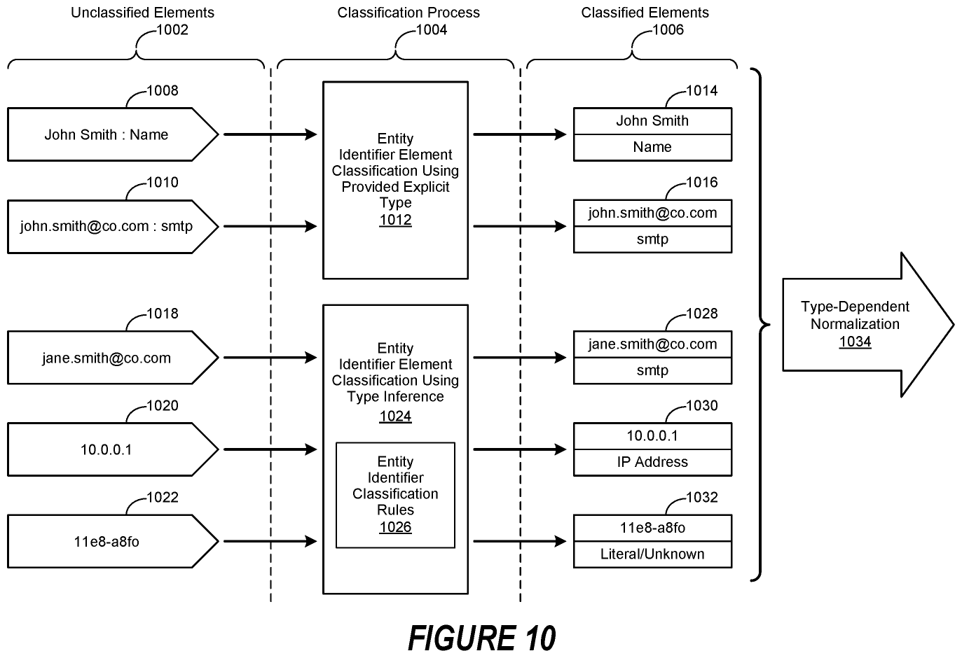

FIG. 9 is a simplified block diagram of a security analytics system implemented in accordance with an embodiment of the invention for providing in-line resolution of an entity's identity. In certain embodiments, a security analytics system 118 may be implemented to monitor user behavior associated with a user, such as user ‘A’ 802. In certain embodiments, the user behavior is monitored during user/device 830, user/network 842, user/resource 848, and user/user 864 interactions. In certain embodiments, the user/user 864 interactions may occur between a first user, such as user ‘A’ 802, and a second user, such as user ‘B’ 862.

In certain embodiments, as likewise described in greater detail herein, an endpoint agent 306 may be implemented on the endpoint device 304 to perform the user behavior monitoring. In certain embodiments, the user behavior may be monitored by the endpoint agent 306 during user/device 830 interactions between a user, such as user ‘A’ 902, and an endpoint device 304. In certain embodiments, the user behavior may be monitored by the endpoint agent 306 during user/network 842 interactions between user ‘A’ 902 and a network, such as an internal 844 or external 846 network.

In certain embodiments, the security analytics 118 system may be implemented to include an in-line entity resolutions system 120, described in greater detail herein. In certain embodiments, the in-line entity resolutions system 120 may be implemented to perform various in-line entity resolution operations, likewise described in greater detail herein. In certain embodiments, the endpoint agent 306 may be implemented in combination with the security analytics system 118, and the in-line entity resolution system 120 to provide in-line resolution of an entity, such as user ‘A’ 802 of user ‘B’ 862.

In certain embodiments, the endpoint agent 306 may be implemented to include an analytics 310 module and an in-line entity resolution feature pack 908. In certain embodiments, the in-line entity resolution feature pack 908 may be further implemented to include an event data detector 910 module, an event data collector 912 module, and an endpoint security policy 914. As used herein, an endpoint security policy 914 broadly refers to a security policy implemented to be revised by the security analytics system 118 to remediate risk associated with certain user behaviors.

In certain embodiments, the security analytics system 118 may be implemented to revise the endpoint security policy 912 as a result of performing certain in-line entity resolution operations, described in greater detail herein. As an example, user ‘B’ 862 may attempt to pose as user ‘A’ 802 in an attempt to illicitly access a particular system 854. However, the performance of certain in-line entity resolution operations during the process of user ‘B’ 862 attempting to access the system 854 may result in the endpoint security policy 914 being revised to prevent access.

In certain embodiments, the event data detector 910 module may be implemented to detect event data, described in greater detail herein, resulting from user/device 830, user/network 842, user/resource 848, and user/user 864 interactions. In certain embodiments, the event data collector 912 module may be implemented to collect the event data detected by the event data detector 910 module into a stream of event data, likewise described in greater detail herein. In certain embodiments, the endpoint agent 306 may be implemented to communicate the stream of event data collected by the event data collector 912 module to the security analytics 118 system.

Referring now to FIG. 9, in-line entity resolution operations are begun in certain embodiments by the security analytics system 118 receiving a stream of event stream data, described in greater detail herein. In certain embodiments, the stream of event data is provided to the security analytics system 118 by the endpoint agent 306. The event stream data is then processed to generate entity identifier information and determine associated event process steps, as likewise described in greater detail herein.

The entity identifier information is then parsed to generate unclassified entity identifier elements, which are then classified and normalized, followed by the association of any related classified and normalized entity identifier elements. In certain embodiments, the in-line entity resolution system 120 may be implemented to parse the entity identifier information into unclassified entity identifier elements. In certain embodiments, the in-line entity resolution system 120 may be implemented to use certain rules stored in a repository of entity identifier rules 772 to parse the entity identifier information into unclassified entity identifier elements. In certain embodiments, the in- line entity resolution system 120 may likewise be implemented to classify, normalize and associate the resulting entity identifier elements as described in greater detail herein.

Certain normalized entity identifier elements are then selected, followed by a determination being made whether the selected normalized entity identifier elements match any other normalized entity identifier elements stored in a repository of entity identifier data 770. In certain embodiments, the normalized entity identifier elements selected to match any other normalized entity identifier elements stored in a repository of entity identifier data 770 are a matter of design choice. If it is determined the selected normalized entity identifier elements do not match any other normalized entity identifier elements stored in the repository of entity identifier data 770, then a decision is made whether to generate a new resolved entity. If it is decided not to, then the entity is marked as being unresolved and the endpoint security policy 914 corresponding to the event and an unresolved entity is enforced. In certain embodiments, the method by which the security policy is enforced is a matter of design choice.

However, if it was decided to generate a new resolved entity, then the normalized entity elements that were previously selected, and their associated entity identifier elements, are processed to generate a new resolved entity, which in turn is added to the repository of entity identifier data 770. However, if it was determined that the selected normalized entity identifier elements match other normalized entity identifier elements stored in a repository of entity identifier data 770, then they are processed with previously resolved entity identifier elements to further resolve the entity.

Thereafter, or once the newly resolved entity is added to a repository of entity identity data 770, parameters of the endpoint security policy 914 corresponding to the event and a resolved entity are checked. Based upon the parameters of the endpoint security policy 914, a decision is then made whether to allow the process associated with the event proceed to the next step. If not, then the security policy corresponding to the event and a resolved entity is enforced. Otherwise, the entity is allowed to proceed to the next step of the process of the event.

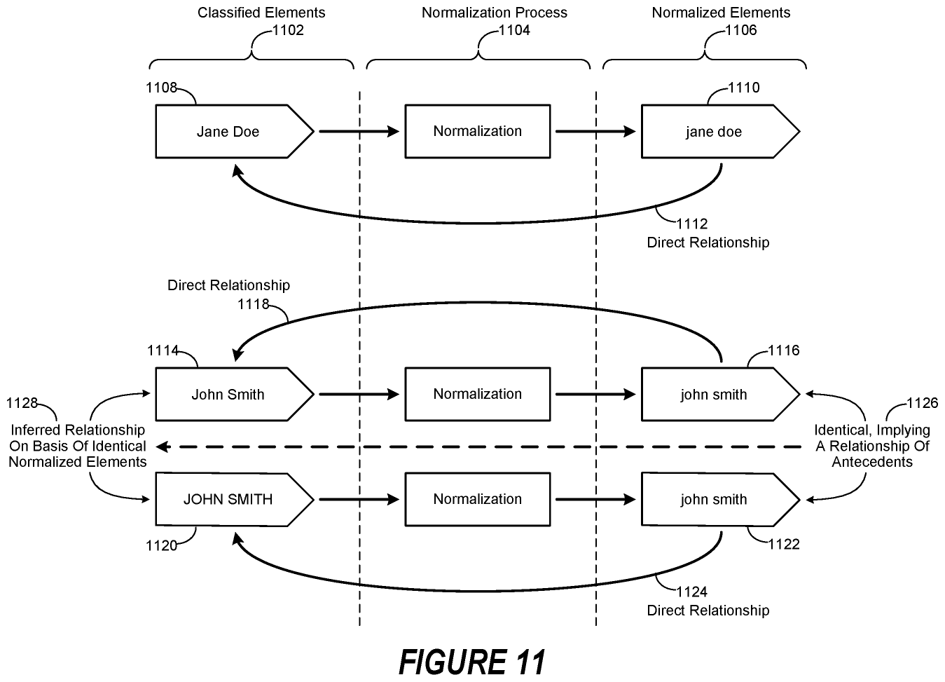

FIG. 10 is a simplified block diagram of entity identifier classification operations performed in accordance with an embodiment of the invention. In certain embodiments, entity identifier information is parsed, as described in greater detail herein, to generate unclassified 1002 entity identifier elements. In certain embodiments, a classification process 1004 may be implemented to generate classified 1006 entity identifier elements from such unclassified 1002 entity identifier elements. In certain embodiments, type-dependent normalization 1034 operations, as described in greater detail herein, are then performed on the resulting classified 1006 entity identifier elements.

In certain embodiments, the classification process 1004 may be implemented to classify a particular entity identifier element according to a provided explicit type 1012. In certain embodiments, the explicit type 1012 of an unclassified entity identifier 1002 may be provided by an external system. In certain embodiments, the explicit type 1012 of an entity identifier element may be unequivocally denoted. In certain embodiments, the unclassified entity identifier 1002 may have an explicit type 1012 appended to its associated particular value. As an example, as shown in FIG. 10, a first 1008 unclassified entity identifier element of “John Smith” may have a provided explicit type of “Name,” while a second 1010 unclassified entity identifier element of “john.smith@co.com” may have a provided explicit type of “smtp.”

In this example, the first 1008 and second 1010 unclassified entity identifier elements are processed with their associated explicit types 1012 to respectively generate a first 1014 and second 1016 classified entity identifier element. Accordingly, the resulting first 1014 classified identifier element has a value of “John Smith” with an associated type of “Name.” Likewise, the resulting second 1016 classified identifier element has a value of “john.smith@co.com” with an associated type of “smtp.”

In certain embodiments, the classification process 1004 may be implemented to use type inference 1024 to classify a particular entity identifier element. In certain embodiments, the classification process 1004 of an entity identifier element through type inference 1024 may be implemented to use various entity identifier classification rules 1026. As an example, as shown in FIG. 10, a third 1018, fourth 1020, and fifth 1022 unclassified entity identifier element may respectively have a value of jane.smith@co.com, “10.0.0.1,” and “11e8-a8fo.”

In this example, the third 1018, fourth 1020, and fifth 1022 unclassified entity identifier elements are classified 1004 using type inference 1024 to respectively generate a third 1028, fourth 1030, and fifth 1032 classified entity identifier element. Accordingly, the resulting third 1028 classified identifier element has a value of “jane.smith@co.com” with an associated type pf “smtp,” while the resulting fourth 1030 classified identifier element has a value of “10.0.0.1” with an associated type of “IP Address.” Likewise, the resulting fifth 1032 classified identifier element has a value of “11e8-a8fo,” with an associated type of “Literal/Unknown.”

To continue the example, the entity identifier classification rules 1026 may include a rule stating an unclassified entity identifier element 1002 containing two names separated by a period, which are then followed by an ampersand symbol, which is in turn followed by an alphanumeric string, which is then followed by a period and a domain extension, is likely an email address. Likewise, the entity identifier classification rules 1026 may include a rule stating that an unclassified entity identifier element 1002 containing four numbers, each of which is three digits or less and separated by a period, is likely an IP address. Skilled practitioners of the art will recognize that many such examples of entity identifier element classification processes 1004, and associated entity identifier classification rules 1026, are possible. Accordingly, the foregoing is not intended to limit the spirit, scope or intent of the invention.

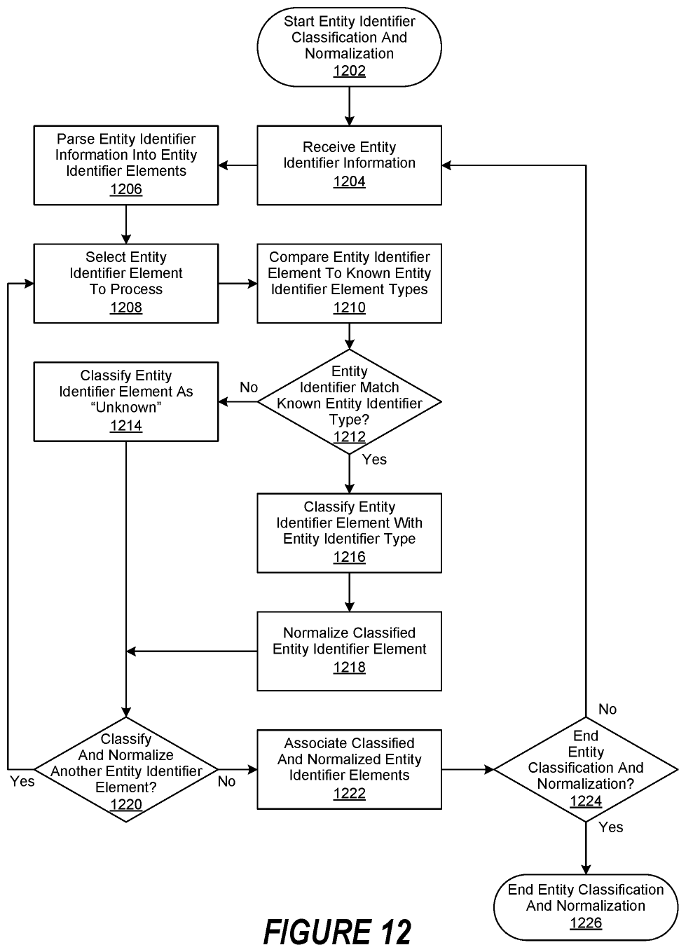

FIG. 11 is a simplified block diagram of entity identifier normalization operations performed in accordance with an embodiment of the invention. In certain embodiments, a normalization process 1104 may be implemented to generate normalized 1106 entity identifier elements from classified 1102 entity identifier elements. In certain embodiments, a resulting normalized 1106 entity identifier element may not have an exact match in a repository of resolved entity identifier data, described in greater detail herein. Accordingly, it may be difficult to establish a relationship with other classified 802 entity identifier elements.

As an example, a normalization process 1104 may be performed on a first 1108 classified entity identifier element having a value of “Jane Doe” to generate a first 1110 normalized entity identifier element with a value of “jane doe.” Accordingly, a direct relationship 1112 can be established between the first 1110 normalized entity identifier element and the first 1108 classified entity identifier element. However, it may be difficult to establish a relationship between the first 1110 normalized entity identifier element and other classified 1102 entity identifier elements if it is the only such normalized 1106 entity identifier element present in a repository of resolved entity identifier data.

In certain embodiments, a resulting normalized 1106 entity identifier element may have an exact match in a repository of resolved entity identifier data. As an example, a normalization process 1104 may be performed on a second 1114 classified entity identifier element having a value of “John Smith” to generate a second 1116 normalized entity identifier element with a value of “john smith.” Accordingly, a direct relationship 1120 can be established between the second 816 normalized entity identifier element and the second 1114 classified entity identifier element.

Likewise, a normalization process 1104 may be performed on a third 1120 classified entity identifier element having a value of “JOHN SMITH” to generate a third 1122 normalized entity identifier element with a value of “john smith.” Accordingly, a direct relationship 1124 can be established between the third 1126 normalized entity identifier element and the third 1120 classified entity identifier element. To continue the example, both the second 1116 and third 1122 normalized entity identifier elements have the same value of “john smith,” which implies 1126 a relationship of antecedents. Consequently, an inferred 1128 relationship can be established between the second 1116 and third 1122 normalized entity identifier elements, based upon their identical values, and second 1114 and third 1120 classified entity identifier elements.

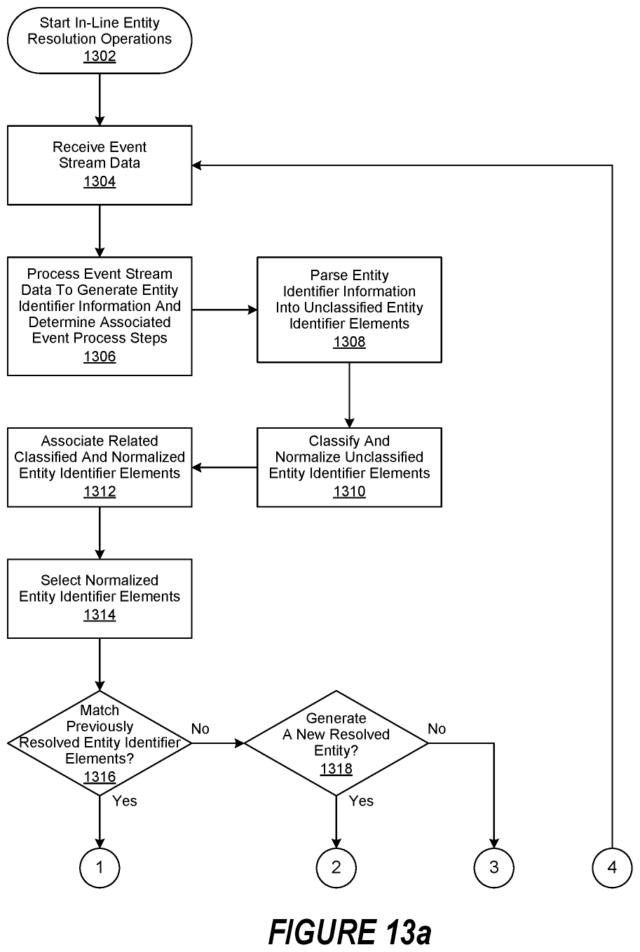

FIG. 12 is a generalized flowchart of the performance of entity identifier element type classification and normalization operations implemented in accordance with an embodiment of the invention. In this embodiment, entity identifier element classification and normalization operations are begun in step 1202, followed by the receipt of entity identifier information in step 1204. The entity identifier information is then parsed, as described in greater detail herein, in step 1206 to generated entity identifier elements.

One of the resulting entity identifier elements is selected in step 1208, followed by the performance of comparison operations in step 1210 to compare it to known entity identifier element types. A determination is then made in step 1212 whether the selected entity identifier element matches any known entity identifier element types. In certain embodiments, the determination of whether the selected entity identifier element matches any known entity identifier element types may be accomplished through the use of one or more entity identifier element classification rules, described in greater detail herein.

If it was determined in step 1212 that the entity identifier element does not match any known entity identifier element types, then the selected entity identifier element is classified with an entity identifier element type of “unknown” in step 1214. Otherwise, the selected entity identifier element is classified with the known entity identifier element type it matches in step 1216. Once classified, the entity identifier element is normalized, as described in greater detail herein, in step 1218. In certain embodiments, the entity identifier element is normalized through the use of one or more entity identifier element normalization rules, described in greater detail herein.

Thereafter, or once the entity identifier element classification operations are completed in step 1214, a determination is made in step 1220 whether to perform classification and normalization operations on another entity identifier element. If so, then the process is continued, proceeding with step 1208. Otherwise, classified and normalized entity identifier elements that are related to one another are associated, as described in greater detail herein, in step 1222. A determination is then made in step 1224 whether to end of entity identifier element type classification and normalization operations. If not, then the process is continued, proceeding with step 1204. Otherwise, of entity identifier element type classification and normalization operations are ended in step 1226.

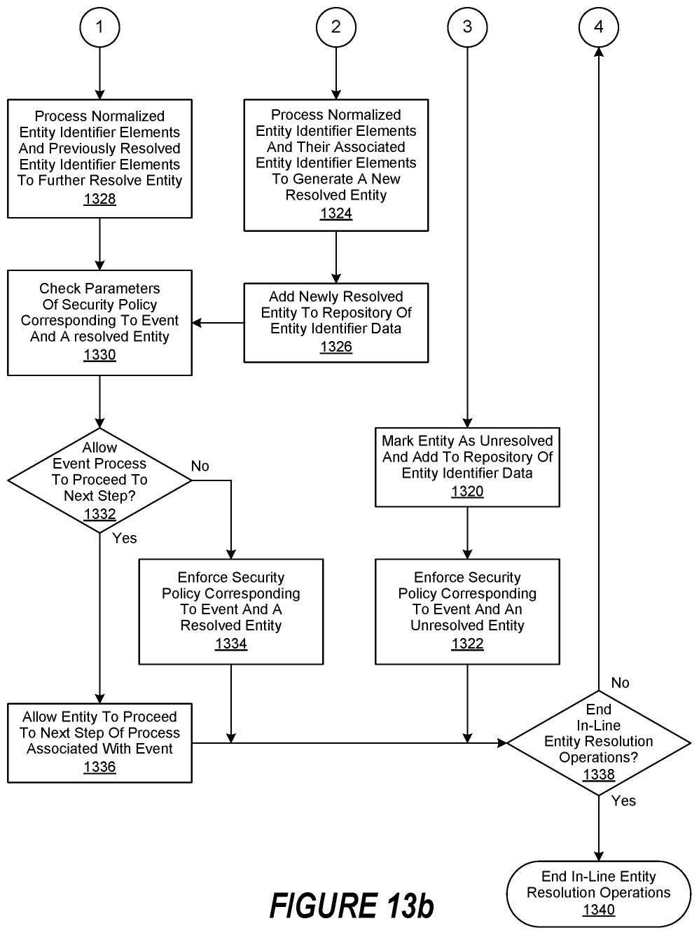

FIGS. 13a and 13b are a generalized flowchart of the performance of operations implemented in accordance with an embodiment of the invention for in-line resolution of an entity's identity. In this embodiment, in-line identity resolution operations are begun in step 1302, followed by receiving event stream data, described in greater detail herein, in step 1304. The event stream data is then processed in step 1306 to generate entity identifier information and determine associated event process steps, as likewise described in greater detail herein.

The entity identifier information is then parsed in step 1308 to generate unclassified entity identifier elements. The resulting unclassified entity identifier elements are then classified and normalized in step 1310, followed by the association of related classified and normalized entity identifier elements in step 1312. Normalized entity identifier elements are then selected in step 1314, followed by a determination being made in step 1316 whether the selected normalized entity identifier elements match any other normalized entity identifier elements stored in a repository of entity identifier data.

If not, then a determination is made in step 1318 whether to generate a new resolved entity. If not, then the entity is marked as being unresolved in step 1320 and the security policy corresponding to the event and an unresolved entity is enforced in step 1322. A determination is then made in step 1338 whether to continue in-line entity resolution operations. If so, then the process is continued, proceeding with step 1304. Otherwise, in-line entity resolution operations are ended in step 1340.

However, if it was determined in step 1318 to generate a new resolved entity, then the normalized entity elements that were selected in step 1314, and their associated entity identifier elements, are processed in step 1324 to generate a new resolved entity, which in turn is added to a repository of entity identifier data in step 1326. However, if it was determined in step 1316 that the selected normalized entity identifier elements match any other normalized entity identifier elements stored in a repository of entity identifier data, then they are processed in step 1328 with previously resolved entity identifier elements to further resolve the entity.

Thereafter, or once the newly resolved entity is added to a repository of entity identity data in step 1326, parameters of the security policy corresponding to the event and a resolved entity are checked in step 1330. Based upon the parameters of the security policy, a determination is then made in step 1332 whether to allow the process associated with the event proceed to the next step. If not, then the security policy corresponding to the event and a resolved entity is enforced in step 1334. Otherwise, the entity is allowed to proceed to the next step of the process of the event in step 1336. Thereafter, or once the security policy corresponding to the event and a resolved entity is enforced in step 1334, the process is continued, proceeding with step 1338.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

1-20. (canceled)

21. A computer-implementable method for resolving an identity of an entity, comprising:
receiving an event stream, the event stream comprising a plurality of events;
extracting an extracted event feature from a particular event of the plurality of events;
parsing entity identifier information using the extracted event feature, the parsing generating entity identifier elements from the entity identify information;
classifying an entity identifier element with an entity identifier element type;
normalizing an entity identifier element to provide a normalized entity identifier element; and,
associating the normalized entity identifier element with the entity to resolve the identity of the entity, the identity of the entity being resolved in-line.

22. The method of claim 21, wherein:
the entity identifier comprises at least one of a user identification factor, a user identify factor, location data, information associated with an endpoint device, information associated with an edge device, information associated with an internal network, information associated with an external network and information associated with a resource entity.

23. The method of claim 21, wherein:
the entity identifier element type comprising a representation of a particular attribute associated with an entity identifier element.

24. The method of claim 21, wherein:
the entity identifier element type comprises at least one of a simple mail transfer protocol (SMTP) address type, an exchange address type and an inferred type; and,
normalizing the entity identifier element is specific to the entity identifier element type.

25. The method of claim 21, wherein:
the associating resulting in a classified and normalized entity identifier element being cross-referenced with another classified and normalized entity identifier element.

26. The method of claim 21, wherein:
the normalizing provides an implicit identifier pair associated with the normalized entity identifier element.

27. A system comprising:
a processor;
a data bus coupled to the processor; and
a non-transitory, computer-readable storage medium embodying computer program code for resolving an identity of an entity, the non-transitory, computer-readable storage medium being coupled to the data bus, the computer program code interacting with a plurality of computer operations and comprising instructions executable by the processor and configured for:
receiving an event stream, the event stream comprising a plurality of events;
extracting an extracted event feature from a particular event of the plurality of events;
parsing entity identifier information using the extracted event feature, the parsing generating entity identifier elements from the entity identify information;
classifying an entity identifier element with an entity identifier element type;
normalizing an entity identifier element to provide a normalized entity identifier element; and,
associating the normalized entity identifier element with the entity to resolve the identity of the entity, the identity of the entity being resolved in-line.

28. The system of claim 27, wherein:
the entity identifier comprises at least one of a user identification factor, a user identify factor, location data, information associated with an endpoint device, information associated with an edge device, information associated with an internal network, information associated with an external network and information associated with a resource entity.

29. The system of claim 27, wherein:
the entity identifier element type comprising a representation of a particular attribute associated with an entity identifier element.

30. The system of claim 27, wherein:
the entity identifier element type comprises at least one of a simple mail transfer protocol (SMTP) address type, an exchange address type and an inferred type; and,
normalizing the entity identifier element is specific to the entity identifier element type.

31. The system of claim 27, wherein:
the associating resulting in a classified and normalized entity identifier element being cross-referenced with another classified and normalized entity identifier element.

32. The system of claim 27, wherein:
the normalizing provides an implicit identifier pair associated with the normalized entity identifier element.

33. A non-transitory, computer-readable storage medium embodying computer program code for resolving an identity of an entity, the computer program code comprising computer executable instructions configured for:
receiving an event stream, the event stream comprising a plurality of events;
extracting an extracted event feature from a particular event of the plurality of events;
parsing entity identifier information using the extracted event feature, the parsing generating entity identifier elements from the entity identify information;
classifying an entity identifier element with an entity identifier element type;
normalizing an entity identifier element to provide a normalized entity identifier element; and,
associating the normalized entity identifier element with the entity to resolve the identity of the entity, the identity of the entity being resolved in-line.

34. The non-transitory, computer-readable storage medium of claim 33, wherein:
the entity identifier comprises at least one of a user identification factor, a user identify factor, location data, information associated with an endpoint device, information associated with an edge device, information associated with an internal network, information associated with an external network and information associated with a resource entity.

35. The non-transitory, computer-readable storage medium of claim 33, wherein:
the entity identifier element type comprising a representation of a particular attribute associated with an entity identifier element.

36. The non-transitory, computer-readable storage medium of claim 33, wherein:
the entity identifier element type comprises at least one of a simple mail transfer protocol (SMTP) address type, an exchange address type and an inferred type; and,
normalizing the entity identifier element is specific to the entity identifier element type.

37. The non-transitory, computer-readable storage medium of claim 33, wherein:
the associating resulting in a classified and normalized entity identifier element being cross-referenced with another classified and normalized entity identifier element.

38. The non-transitory, computer-readable storage medium of claim 33, wherein:
the normalizing provides an implicit identifier pair associated with the normalized entity identifier element.

39. The non-transitory, computer-readable storage medium of claim 33, wherein:
the computer executable instructions are deployable to a client system from a server system at a remote location.

40. The non-transitory, computer-readable storage medium of claim 33, wherein:
the computer executable instructions are provided by a service provider to a user on an on-demand basis.
